(19) United States
(12) Patent Application Publication
(10) Pub. No.: US 2024/0292444 A1
(43) Pub. Date: Aug. 29, 2024

(54) SIDELINK IN-DEVICE CO-EXISTENCE INTERFERENCE MITIGATION

(71) Applicant: QUALCOMM Incorporated, San Diego, CA (US)

(72) Inventors: Sherif Elazzouni, San Diego, CA (US); Ozcan Ozturk, San Diego, CA (US)

(21) Appl. No.: 18/176,460

(22) Filed: Feb. 28, 2023

(51) Int. Cl. H04W 72/541; H04L 5/00; H04W 72/25; H04W 76/19

(52) U.S. Cl. CPC H04W 72/541; H04L 5/0092; H04W 72/25; H04W 76/19

(57) ABSTRACT

Methods, systems, and devices for wireless communications are described. A user equipment (UE) may receive, from a second UE, reporting information for indicating in-device co-existence (IDC) interference. The UE may receive, from the second UE, a resource reservation message indicating a set of sidelink resources, and may transmit, to the second UE according to the reporting information, an IDC interference report indicating IDC interference corresponding to at least a portion of the set of sidelink resources.

### FIELD OF TECHNOLOGY

The following relates to wireless communications, including sidelink in-device co-existence (IDC) interference mitigation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support sidelink in-device co-existence (IDC) interference mitigation. For example, a user equipment (UE) may detect and report IDC interference that impacts sidelink communication, and a transmitting device may schedule resources for sidelink communication based on the reported IDC interference (e.g., may schedule resources to avoid resources that are impacted by IDC interference). In some examples (e.g., when the UE is operating in an autonomous resource selection mode), a receiving UE may receive configuration information from the transmitting UE indicating parameters for reporting IDC interference to the transmitting UE. The receiving UE may detect IDC interference, and then transmit an IDC interference report to the transmitting UE. The transmitting UE may configure the reporting via radio resource control (RRC) signaling, or as a measurement object (e.g., sidelink assistance info, sidelink measurement object, inter-UE coordination information, among other examples). The receiving UE may transmit the IDC interference report as part of upper layer signaling (RRC signaling), a radio link failure, or the like. The receiving UE may report specific subchannels, resource pools, channels, or the like, that are experiencing IDC interference. The transmitting UE may reserve subsequent sidelink resources to avoid the indicated resources.

In some examples (e.g., when a UE is operating in a mode where a network entity schedules resources for sidelink transmissions), the transmitting UE, the receiving UE, or both, may report IDC interference to the network entity, which may avoid the indicated resources for future sidelink grants. The UEs may transmit the IDC interference report to the network entity via RRC signaling during network configuration, UE assistance information, or the two UEs may communicate with each other, and one UE may transmit identified IDC interference to the network entity. In some cases, the IDC interference report may indicate interference affecting specific radio access technologies (RATs). In some examples, the UEs may report power co-existence solutions to the network entity.

A method for wireless communications at a first user equipment (UE) is described. The method may include receiving, from a second UE, reporting information for indicating in-device co-existence interference, receiving, from the second UE, a resource reservation message indicating a set of sidelink resources, and transmitting, to the second UE according to the reporting information, an in-device co-existence interference report indicating in-device co-existence interference corresponding to at least a portion of the set of sidelink resources.

An apparatus for wireless communications at a first UE is described. The apparatus may include a processor, memory coupled with the processor, and instructions stored in the memory. The instructions may be executable by the processor to cause the apparatus to receive, from a second UE, reporting information for indicating in-device co-existence interference, receive, from the second UE, a resource reservation message indicating a set of sidelink resources, and transmit, to the second UE according to the reporting information, an in-device co-existence interference report indicating in-device co-existence interference corresponding to at least a portion of the set of sidelink resources.

Another apparatus for wireless communications at a first UE is described. The apparatus may include means for receiving, from a second UE, reporting information for indicating in-device co-existence interference, means for receiving, from the second UE, a resource reservation message indicating a set of sidelink resources, and means for transmitting, to the second UE according to the reporting information, an in-device co-existence interference report indicating in-device co-existence interference corresponding to at least a portion of the set of sidelink resources.

A non-transitory computer-readable medium storing code for wireless communications at a first UE is described. The code may include instructions executable by a processor to receive, from a second UE, reporting information for indicating in-device co-existence interference, receive, from the second UE, a resource reservation message indicating a set of sidelink resources, and transmit, to the second UE according to the reporting information, an in-device co-existence interference report indicating in-device co-existence interference corresponding to at least a portion of the set of sidelink resources.

In some examples of the method, apparatuses, and non-transitory computer-readable medium described herein, receiving the reporting information may include operations, features, means, or instructions for receiving sidelink RRC signaling including the reporting information, where the reporting information includes an indication that in-device co-existence interference reporting by the first UE may be enabled.

Some examples of the method, apparatuses, and non-transitory computer-readable medium described herein may further include operations, features, means, or instructions for receiving, in the sidelink RRC signaling, an indication of a center frequency around which the first UE may be requested to report the in-device co-existence interference, an indication of a sidelink resource pool for reporting the in-device co-existence interference, an indication of one or more subchannels associated with reporting the in-device co-existence interference, an indication of one or more active sidelink bandwidth parts or inactive sidelink bandwidth parts for corresponding to the in-device co-existence interference, or any combination thereof.

In some examples of the method, apparatuses, and non-transitory computer-readable medium described herein, receiving the reporting information may include operations, features, means, or instructions for receiving a measurement object configuration message, a sidelink assistance information message or an inter-UE coordination information message.

Some examples of the method, apparatuses, and non-transitory computer-readable medium described herein may further include operations, features, means, or instructions for transmitting, in the in-device co-existence interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by the in-device co-existence interference.

In some examples of the method, apparatuses, and non-transitory computer-readable medium described herein, transmitting the in-device co-existence interference report may include operations, features, means, or instructions for transmitting an indication of a link failure associated with the set of sidelink resources due to the in-device co-existence interference.

Some examples of the method, apparatuses, and non-transitory computer-readable medium described herein may further include operations, features, means, or instructions for receiving, in the reporting information, event-triggered measurement object configuration and detecting the in-device co-existence interference based on monitoring the set of sidelink resources in accordance with the even-triggered measurement object configuration, where transmitting the in-device co-existence interference report includes transmitting a media access control (MAC) control element (CE) based on detecting the in-device co-existence interference.

In some examples of the method, apparatuses, and non-transitory computer-readable medium described herein, transmitting the in-device co-existence interference report may include operations, features, means, or instructions for groupcasting the in-device co-existence interference report to a set of multiple sidelink UEs including the second UE.

In some examples of the method, apparatuses, and non-transitory computer-readable medium described herein, transmitting the in-device co-existence interference report may include operations, features, means, or instructions for transmitting an inter-UE coordination message including an indication that a set of multiple sidelink resources including at least the portion of the set of sidelink resources may be non-preferred resources.

Some examples of the method, apparatuses, and non-transitory computer-readable medium described herein may further include operations, features, means, or instructions for receiving, from the second UE, a request for an indication of non-preferred resources, where transmitting the inter-UE coordination message may be based on receiving the request.

Some examples of the method, apparatuses, and non-transitory computer-readable medium described herein may further include operations, features, means, or instructions for receiving configuration information indication one or more conditions, where transmitting the inter-UE coordination message may be based on the one or more conditions being satisfied.

Some examples of the method, apparatuses, and non-transitory computer-readable medium described herein may further include operations, features, means, or instructions for receiving, from the second UE, an indication that the second UE may be capable of receiving the inter-UE coordination message, where transmitting the inter-UE coordination message may be based on receiving the indication that the second UE may be capable of receiving the inter-UE coordination message.

Some examples of the method, apparatuses, and non-transitory computer-readable medium described herein may further include operations, features, means, or instructions for transmitting, in the inter-UE coordination message, an indication of a first subset of the set of multiple sidelink resources that may be non-preferred due to in-device co-existence interference.

Some examples of the method, apparatuses, and non-transitory computer-readable medium described herein may further include operations, features, means, or instructions for monitoring for sidelink signaling from the second UE based on the resource reservation message and detecting the in-device co-existence interference on at least the portion of the set of sidelink resources based on the monitoring, where transmitting the in-device co-existence interference report may be based on detecting the in-device co-existence interference.

A method for wireless communications at a first UE is described. The method may include receiving, from a network entity, a resource reservation message indicating a set of sidelink resources for performing sidelink communications with at least a second UE, communicating with the second UE according to the resource reservation message, and transmitting, to the network entity based on performing the sidelink communications, an in-device co-existence interference report indicating in-device co-existence interference corresponding to at least a portion of the set of sidelink resources.

An apparatus for wireless communications at a first UE is described. The apparatus may include a processor, memory coupled with the processor, and instructions stored in the memory. The instructions may be executable by the processor to cause the apparatus to receive, from a network entity, a resource reservation message indicating a set of sidelink resources for performing sidelink communications with at least a second UE, communicate with the second UE according to the resource reservation message, and transmit, to the network entity based on performing the sidelink communications, an in-device co-existence interference report indicating in-device co-existence interference corresponding to at least a portion of the set of sidelink resources.

Another apparatus for wireless communications at a first UE is described. The apparatus may include means for receiving, from a network entity, a resource reservation message indicating a set of sidelink resources for performing sidelink communications with at least a second UE, means for communicating with the second UE according to the resource reservation message, and means for transmitting, to the network entity based on performing the sidelink communications, an in-device co-existence interference report indicating in-device co-existence interference corresponding to at least a portion of the set of sidelink resources.

A non-transitory computer-readable medium storing code for wireless communications at a first UE is described. The code may include instructions executable by a processor to receive, from a network entity, a resource reservation message indicating a set of sidelink resources for performing sidelink communications with at least a second UE, communicate with the second UE according to the resource reservation message, and transmit, to the network entity based on performing the sidelink communications, an in-device co-existence interference report indicating in-device co-existence interference corresponding to at least a portion of the set of sidelink resources.

In some examples of the method, apparatuses, and non-transitory computer-readable medium described herein, transmitting the in-device co-existence interference report may include operations, features, means, or instructions for transmitting an RRC message including an indication of at least the portion of the set of sidelink resources experiencing the in-device co-existence interference.

In some examples of the method, apparatuses, and non-transitory computer-readable medium described herein, transmitting the in-device co-existence interference report may include operations, features, means, or instructions for transmitting a UE assistance information message including an indication of at least the portion of the set of sidelink resources experiencing the in-device co-existence interference.

Some examples of the method, apparatuses, and non-transitory computer-readable medium described herein may further include operations, features, means, or instructions for receiving, from the second UE, an indication of the in-device co-existence interference, where transmitting the in-device co-existence interference report includes forwarding the indication of the in-device co-existence interference to the network entity.

In some examples of the method, apparatuses, and non-transitory computer-readable medium described herein, transmitting the in-device co-existence interference report may include operations, features, means, or instructions for transmitting an indication of the in-device co-existence interference associated with the set of sidelink resources of a first radio access technology impacting wireless communications via a second radio access technology.

Some examples of the method, apparatuses, and non-transitory computer-readable medium described herein may further include operations, features, means, or instructions for transmitting, in the in-device co-existence interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by in-device co-existence interference.

### BRIEF DESCRIPTION OF THE DRAWINGS

FIG. 1 illustrates an example of a wireless communications system that supports sidelink in-device co-existence (IDC) interference mitigation in accordance with one or more aspects of the present disclosure.

FIG. 2 illustrates an example of a wireless communications system that supports sidelink IDC interference mitigation in accordance with one or more aspects of the present disclosure.

FIG. 3 illustrates examples of timelines that support sidelink IDC interference mitigation in accordance with one or more aspects of the present disclosure.

FIG. 4 illustrates an example of a wireless communications system that supports sidelink IDC interference mitigation in accordance with one or more aspects of the present disclosure.

FIG. 5 illustrates an example of a process flow that supports sidelink IDC interference mitigation in accordance with one or more aspects of the present disclosure.

FIG. 6 illustrates an example of a process flow that supports sidelink IDC interference mitigation in accordance with one or more aspects of the present disclosure.

FIG. 7 illustrates an example of a process flow that supports sidelink IDC interference mitigation in accordance with one or more aspects of the present disclosure.

FIGS. 8 and 9 illustrate block diagrams of devices that support sidelink IDC interference mitigation in accordance with one or more aspects of the present disclosure.

FIG. 10 illustrates a block diagram of a communications manager that supports sidelink IDC interference mitigation in accordance with one or more aspects of the present disclosure.

FIG. 11 illustrates a diagram of a system including a device that supports sidelink IDC interference mitigation in accordance with one or more aspects of the present disclosure.

FIGS. 12 through 15 illustrate flowcharts showing methods that support sidelink IDC interference mitigation in accordance with one or more aspects of the present disclosure.

### DETAILED DESCRIPTION

In some examples, a device (e.g., a user equipment (UE)) may experience in-device co-existence (IDC) interference. For example, a UE may support various types of communication, including fourth generation (4G) technologies such as Long Term Evolution (LTE), LTE-Advanced (LTE-A), or LTE-A Pro, fifth generation (5G) technologies which may be referred to as New Radio (NR), and other wireless technologies such as Wi-Fi or Bluetooth. 4G and 5G technologies may include sidelink communications for direct communication between UEs. Sidelink communications may be performed according to a first mode (e.g., mode 1) in which a network entity schedules sidelink resources for communications between sidelink UEs, or a second mode (e.g., mode 2) in which a transmitting sidelink UE reserves sidelink resources (e.g., from a configured resource pool) for communicating with a receiving sidelink UE.

Some radio transceivers at a UE may be in close proximity with each other. The transmit power of a transmitting device may be higher than the received power of a signal from another device. Additionally, or alternatively, for some co-existence scenarios (e.g., different radio technologies within the same UE operating on adjacent frequencies), filtering procedures may not sufficiently avoid or mitigate interference across adjacent frequencies, between proximate radio transceivers, or the like. In some examples, a UE may not be capable of addressing or minimizing IDC interference in real time. Without a mechanism for indicating or reporting problematic frequency resources on which IDC interference is experienced, some wireless communications (e.g., sidelink communications) may fail, resulting in an increase in retransmissions, inefficient use of available system resources, increased system latency, and decreased user experience.

As described herein, a UE may detect and report IDC interference that impacts sidelink communication, and a transmitting device may schedule resource for sidelink communication based on the reported IDC interference (e.g., may schedule resources to avoid resources that are impacted by IDC interference). In some examples described herein (e.g., when the UEs are operating in mode 2), a receiving UE may receive configuration information from the transmitting UE indicating parameters for reporting IDC interference to the transmitting UE. The receiving UE may detect IDC interference, and then transmit an IDC interference report to the transmitting UE. The transmitting UE may configure the reporting via radio resource control (RRC signaling), or as a measurement object (e.g., sidelink assistance info, sidelink measurement object, inter-UE coordination information, among other examples). The receiving UE may transmit the IDC interference report as part of upper layer signaling (RRC signaling), a radio link failure, or the like. The receiving UE may report specific subchannels, resource pools, channels, or the like, that are experiencing IDC interference. The transmitting UE may reserve subsequent sidelink resources to avoid the indicated resources.

In some examples (e.g., when a UE is operating in mode 1), the transmitting UE, the receiving UE, or both, may report IDC interference to the network entity, which may avoid the indicated resources for future sidelink grants. The UEs may transmit the IDC interference report to the network entity via RRC signaling during network configuration, UE assistance information, or the two UEs may communicate with each other, and one UE may transmit identified IDC interference to the network entity. In some cases, the IDC interference report may indicate interference affecting specific radio access technologies (RATs). In some examples, the UEs may report power co-existence solutions to the network entity (e.g., a UE may indicate to the network entity that it will change power settings, such as transmit power, to mitigate IDC interference, that the UE supports IDC interference reporting based on the transmit power changes, or the like).

Aspects of the disclosure are initially described in the context of wireless communications systems. Aspects of the disclosure are further illustrated by and described with reference to wireless communications systems, timelines, and process flows. Aspects of the disclosure are further illustrated by and described with reference to apparatus diagrams, system diagrams, and flowcharts that relate to sidelink IDC interference mitigation.

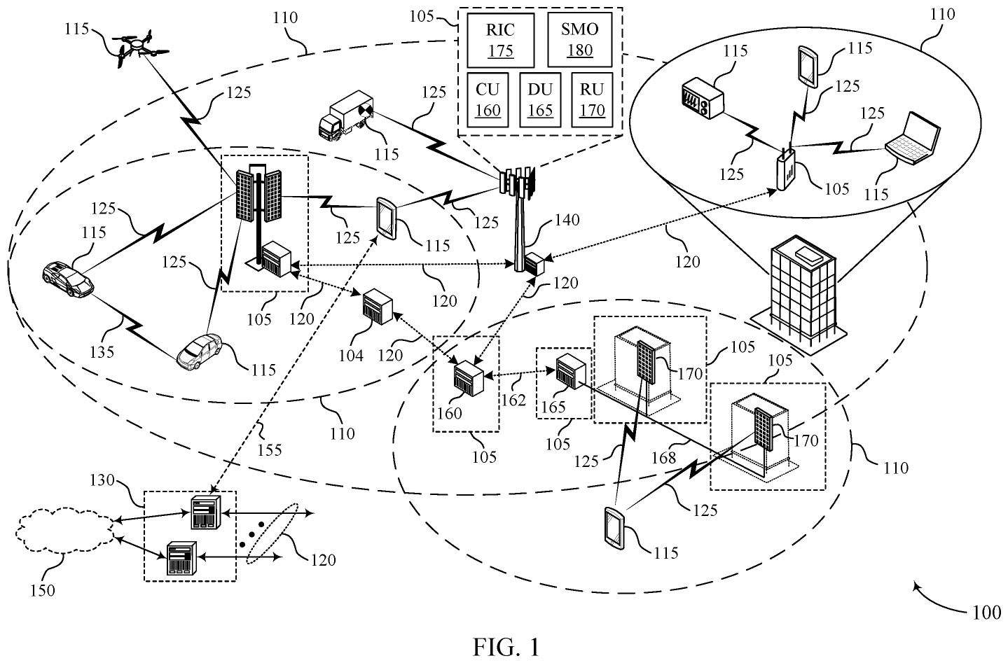

FIG. 1 illustrates an example of a wireless communications system 100 that supports sidelink IDC interference mitigation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support sidelink IDC interference mitigation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, as described herein, a UE 115 (e.g., the UE 115-a) may detect and report IDC interference that impacts sidelink communication, and a transmitting device (e.g., the network entity 105-a, or the UE 115) may schedule resources for sidelink communication based on the reported IDC interference (e.g., may schedule resources to avoid resources that are impacted by IDC interference). In some examples described herein (e.g., when the UE 115 and the UE 115 are operating in mode 2), a receiving UE 115 may receive configuration information from the transmitting UE 115 indicating parameters for reporting IDC interference to the UE 115. The receiving UE 115 may detect IDC interference, and then transmit an IDC interference report to the transmitting UE 115. The transmitting UE 115 may configure the reporting via RRC signaling, or as a measurement object (e.g., sidelink assistance info, sidelink measurement object, inter-UE coordination information, among other examples). The receiving UE 115 may transmit the IDC interference report as part of upper layer signaling (RRC signaling), a radio link failure, or the like. The UE 115 may report specific subchannels, resource pools, channels, or the like, that are experiencing IDC interference. The transmitting UE 115 may reserve subsequent sidelink resources to avoid the indicated resources.

In some examples (e.g., when the UE 115 is operating in mode 1), the transmitting UE 115, the receiving UE 115, or both, may report IDC interference to the network entity 105, which may avoid the indicated resources for future sidelink grants. The UEs 115 may transmit the IDC interference report to the network entity via RRC signaling during network configuration, UE assistance information, or the two UEs may communicate with each other, and one UE 115 may transmit identified IDC interference to the network entity 105. In some cases, the IDC interference report may indicate interference affecting specific RATs. In some examples, the UEs 115 may report power co-existence solutions to the network entity 105.

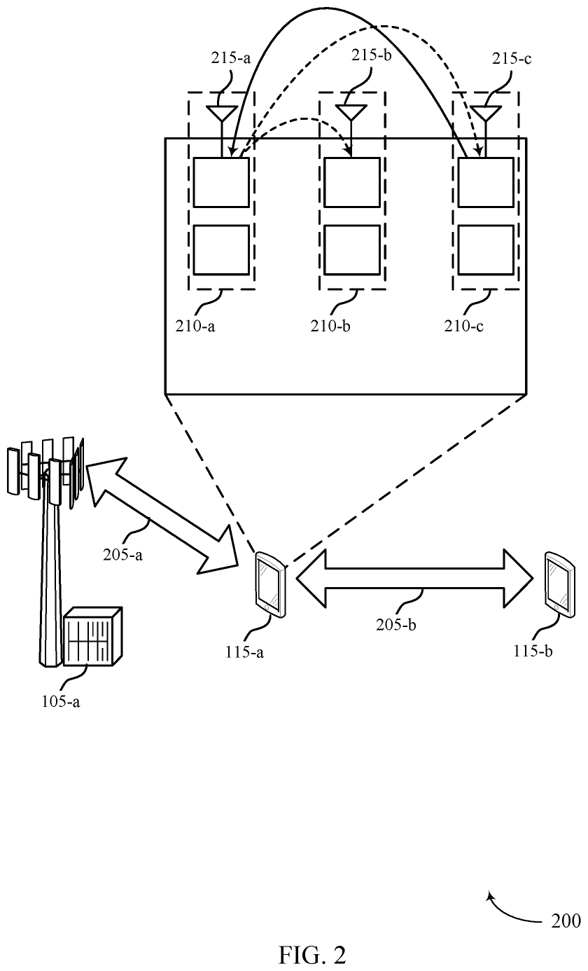

FIG. 2 illustrates an example of a wireless communications system 200 that supports sidelink IDC interference mitigation in accordance with one or more aspects of the present disclosure. The wireless communications system 200 may implement aspects of, or be implemented by aspects of, the wireless communications system 100. For example, the wireless communications system 200 may include a network entity 105-a, and one or more UEs 115 (e.g., the UE 115-a and the UE 115-b), which may be examples of corresponding devices described with reference to FIG. 1.

The UE 115-a and the UE 115-b may communicate with each other via a wireless communication link 205-b (e.g., via sidelink communication). The network entity 105-a may communicate with one or more UEs 115 (e.g., the UE 115-a) via a wireless communication link 205-a (e.g., a Uu link). The UE 115-a and the UE 115-b may communicate according to a first sidelink mode (e.g., mode 1, in which the network entity 105-a allocates sidelink resources for sidelink communications between the UE 115-a and the UE 115-b) or a second sidelink mode (e.g., mode 2, in which the transmitting UE 115-a allocates sidelink resources for sidelink communications between the UE 115-a and the UE 115-b).

In some examples, one or more UEs 115 may experience IDC interference. For example, the UE 115-a may support one or more transceivers 210 (e.g., associated with multiple transmit/receive chains). For example, transceiver 210-a may be associated with a first RAT (e.g., a cellular or NR technology associated with an NR baseband and communications via antenna 215-a), transceiver 210-b may be associated with a second RAT (e.g., GPS associated with a GPS baseband and communications via antenna 215-b), and transceiver 210-c may be associated with a third RAT (e.g., a Bluetooth or Wi-Fi technology associated with an NR baseband and communications via antenna 215-c).

Communications via one transceiver 210 may result in IDC interference for another transceiver 210. For example, NR communications via the transceiver 210-a (e.g., and the antenna 215-a) may result in IDC interference for the transceiver 210-b (e.g., and the antenna 215-b), the transceiver 210-c (e.g., and the antenna 215-b), or both. Similarly, Bluetooth or Wi-Fi______33 signaling via the transceiver 210-c (e.g., and the antenna 215-c) may cause interference for one or more transceivers 210 (e.g., the transceiver 210-a). Such IDC interference may degrade the quality of communications via one or more RATs, increase signaling overhead and system latency, degrade the reliability of communications, and decrease user experience.

IDC interference may result from a proximity of the radio transceivers 210 within the UE 115-a. In some examples, the transmit power of a transmitter (e.g., via a transceiver 210) may be higher than a received power of a signal received via a receiver (e.g., via another transceiver 210). In such examples, a relatively small amount of IDC interference from the transmission via the transceiver 210 may affect receiving and decoding of a received signal at the other transceiver 210 In some examples (e.g., where different RATs operate on adjacent frequency resources), filtering by one transceiver 210 at the UE 115-a may not sufficiently address IDC interference. Moreover, in some examples, a single radio frequency design (e.g., at a single transceiver 210) for addressing or filtering IDC interference may not be supported by the UE 115-a.

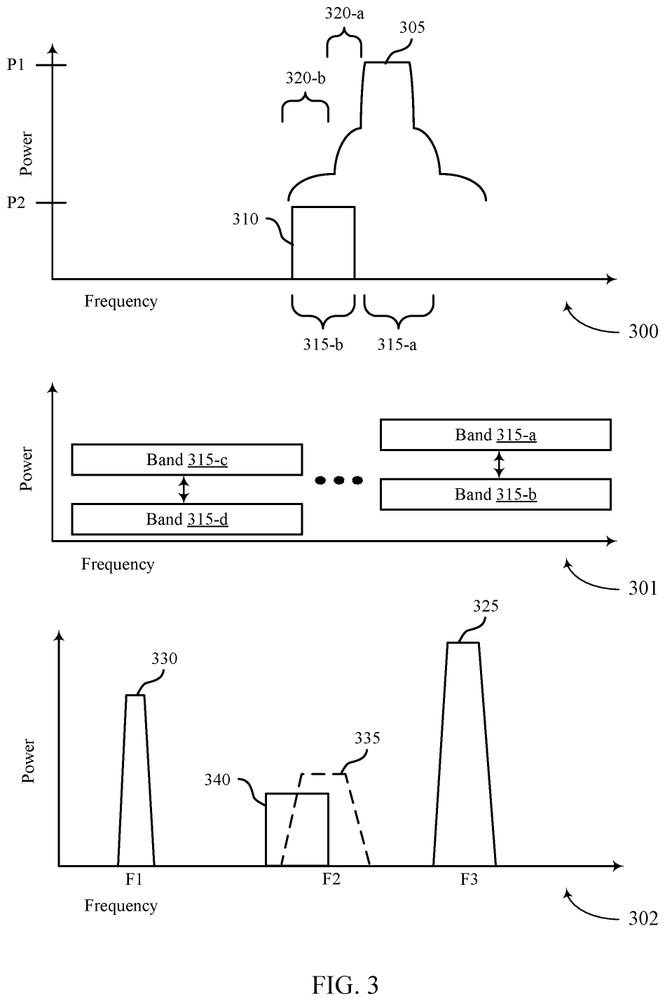

IDC interference may occur for various RATs using different frequency resources (e.g., adjacent, overlapping, or proximately located ranges of frequency resources). For instance, a first band and a second band (e.g., an NR band spanning 2300 to 2400 MHz and a second NR band spanning 2496 to 3690 MHz) may be allocated for NR communications, while a third band (e.g., 2400 MHz to 2483.5 MHz, including up to 79 channels) may be allocated for Wi-Fi or Bluetooth communications. In such examples, NR communications may cause IDC interference for Wi-Fi or Bluetooth reception, and vice versa. Similarly, uplink communications via NR bands may cause interference for global navigation satellite system (GNSS) channels, or Indian regional navigation satellite system (IRNSS) navigation or positioning systems. Additionally, or alternatively, mmWave communications (e.g., via sub 6 MHz channels) may create mutual interference based on used channels, or transmit chain sharing, among other examples. Examples of IDC interference are described in greater detail with reference to FIG. 3.

In some examples, as described herein, a UE 115 (e.g., the UE 115-a) may detect and report IDC interference that impacts sidelink communication, and a transmitting device (e.g., the network entity 105-a, or the UE 115-b) may schedule resource for sidelink communication (e.g., via the communication link 205-b) based on the reported IDC interference (e.g., may schedule resources to avoid resources that are impacted by IDC interference). In some examples described herein (e.g., when the UE 115-a and the UE 115-b are operating in mode 2), a receiving UE 115 (e.g., the UE 115-a) may receive configuration information from the transmitting UE 115 (e.g., the UE 115-b) indicating parameters for reporting IDC interference to the UE 115-b. The receiving UE 115-a may detect IDC interference, and then transmit an IDC interference report to the transmitting UE 115-b. The transmitting UE 115-b may configure the reporting via RRC signaling, or as a measurement object (e.g., sidelink assistance info, sidelink measurement object, inter-UE coordination information, among other examples). The receiving UE 115-a may transmit the IDC interference report as part of upper layer signaling (RRC signaling), a radio link failure, or the like. The UE 115-a may report specific subchannels, resource pools, channels, or the like, that are experiencing IDC interference. The transmitting UE 115-b may reserve subsequent sidelink resources to avoid the indicated resources.

In some examples (e.g., when the UE 115-a and the UE 115-b are operating in mode 1), the transmitting UE 115-b, the receiving UE 115-a, or both, may report IDC interference to the network entity 105-a, which may avoid the indicated resources for future sidelink grants. The UEs 115 may transmit the IDC interference report to the network entity via RRC signaling during network configuration, UE assistance information, or the two UEs may communicate with each other, and one UE 115 (e.g., the UE 115-a) may transmit identified IDC interference to the network entity 105-a. In some cases, the IDC interference report may indicate interference affecting specific RATs. In some examples, the UEs 115 may report power co-existence solutions to the network entity 105-a.

FIG. 3 illustrates examples of timelines (e.g., timeline 300, timeline 301, and timeline 302) that support sidelink IDC interference mitigation in accordance with one or more aspects of the present disclosure. FIG. 3 may implement aspects of, or be implemented by aspects of, the wireless communications system 100 and wireless communications system 200. For example, a UE (e.g., which may correspond to similar devices such as UEs 115 described with reference to FIGS. 1 and 2) may communicate according to timeline 300, timeline 301, timeline 302, or any combination thereof, and may experience and report IDC interference as described herein.

In some examples, a UE communicating according to timeline 300 may experience IDC interference. For example, the UE may transmit a signal 305 according to a first RAT (e.g., a Wi-Fi transmission) via a band 315-a (e.g., a 5 GHz band, such as a 5.15 to 5.85 GHz frequency band), and may also receive a signal 310 (e.g., a cellular or NR transmission) via a band 315-b (e.g., an NR channel such as a 4.4 to 5.0 GHz band). Although the band 315-a and the band 315-b may not overlap in frequency, a receiver associated with the signal 310 may experience IDC interference resulting from the signal 305. For example, the signal 305 may be transmitted at a transmit power (P1), and the signal 310 may be received at a receive power (P2), which may be lower than the power of P1. Although the UE may transmit the signal 305 via the band 315-a, out of band (OOB) emissions may occur via frequency resources 320-a, spurious emissions may occur via frequency resources 320-b, or a combination thereof. In such examples, a portion of the transmission via the band 315-a, the OOB emissions, the spurious emissions, or any combination thereof, may result in IDC interference for reception of the signal 310.

In such examples, IDC interference may be caused by an NR transmission to another RAT (e.g., Wi-Fi signaling), or by another RAT to NR reception, or both, due to operational bands (e.g., band 315-a) that are adjacent to ISM bands (e.g., band 315-b). Similarly, according to the timeline 301, the UE may communicate via adjacent, or nearby, bands 315. For instance, the UE may communicate via a band 315-c (e.g., a 2.4 GHz band such as a 2.402 to 2.482 GHz band for Wi-Fi or Bluetooth signaling), and a band 315-d (e.g., an NR band such as a 2.496 to 2.690 GHz band). Transmissions via the band 315-c may generate IDC interference for the band 315-d (e.g., or vice versa). Similarly, the UE may communicate via a band 315-a (e.g., a 5 GHz band such as a 5.15 to 5.85 GHz band for Wi-Fi or Bluetooth signaling), and a band 315-d (e.g., an NR band such as a 4.4 to 5.0 GHz band). Transmissions via the band 315-a may generate IDC interference for the band 315-b (e.g., as described with reference to the timeline 300).

In some examples, a UE may experience IDC interference, such as inter-modulation distortion (IMD) interference due to dual connectivity (e.g., new radio dual connectivity (NR-DC)). For example, the UE may perform simultaneous transmissions via different RATs. The UE may transmit a signal 325 (e.g., an NR transmission) via a band located at frequency F3 (e.g., 4450 MHz), and may simultaneously (e.g., overlapping at least partially in time) transmit a signal 330 (e.g., an LTE transmission) via a band located at frequency F1 (e.g., 1940 MHz). The UE may transmit the uplink transmissions via a master cell group (MCG) and a secondary cell group (e.g., SCG), in a dual connectivity scenario (e.g., NR-DC, or E-UTRAN dual connectivity (EN-DC), among other examples).The IMD interference may occur due to the simultaneous transmission and the combination of operational bands used during the dual connectivity operation. For instance, the simultaneous transmission of the signal 325 and the signal 330 may result in interference 335 (e.g., at a frequency F2, such as 2510 MHz), which may impact reception of a signal 340 (e.g., using another RAT, such as a Wi-Fi transmission via a band such as a 2.4 GHz band).

In some examples, the UE may attempt to address IDC interference, such as the IDC interference described with reference to FIG. 3, by performing power allocation solutions. Dynamic or semi-static power allocation procedures (e.g., for physical layer purposes and synchronization) may be applied, such as inter-band FDM co-existence with static power assignments for each carrier. However, in such schemes, synchronization between sidelink UEs may not occur. When transmissions from one sidelink transmission overlap with reception for another, inter-band FDM co-existence may not be feasible if inter-band separations are not large enough (e.g., do not exceed a threshold). For inter-band and intra-band FDM co-existence with dynamic power sharing, a UE may drop or sacrifice transmission from some RATs in favor of transmission associated with other RATs (e.g., according to one or more rules). However, such techniques may not support sidelink transmissions, or may result in dropped, degraded, or otherwise deprioritized sidelink transmissions.

IDC interference, as described with reference to FIG. 3, may thus degrade sidelink communications (e.g., or any type of wireless communications), and a UE may not support mechanisms for identifying, mitigating, or avoiding such IDC interference. As described herein, a UE may identify IDC interference (e.g., that impacts sidelink resources), and may report IDC interference to a transmitting sidelink UE, or to a network entity, or both.

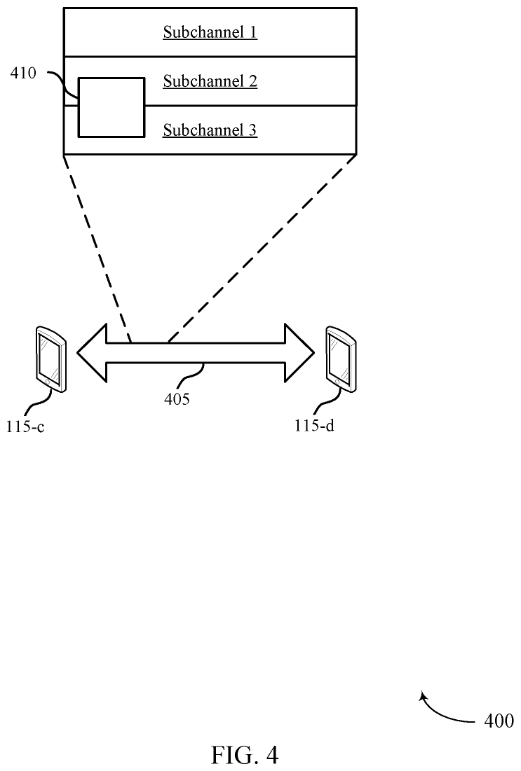

As described in greater detail with reference to FIGS. 4-7, a UE may detect and report IDC interference that impacts sidelink communication, and a transmitting device may schedule resource for sidelink communication based on the reported IDC interference (e.g., may schedule resources to avoid resources that are impacted by IDC interference). In some examples described herein (e.g., when the UE and the UE 115-b are operating in mode 2), a receiving UE may receive configuration information from the transmitting UE indicating parameters for reporting IDC interference to the transmitting UE. The receiving UE may detect IDC interference, and then transmit an IDC interference report to the transmitting UE 115-b. The transmitting UE may configure the reporting via RRC signaling, or as a measurement object (e.g., sidelink assistance info, sidelink measurement object, inter-UE coordination information, among other examples). The receiving UE may transmit the IDC interference report as part of upper layer signaling (RRC signaling), a radio link failure, or the like. The receiving UE may report specific subchannels, resource pools, channels, or the like, that are experiencing IDC interference. The transmitting UE may reserve subsequent sidelink resources to avoid the indicated resources.

In some examples (e.g., when a UE is operating in mode 1), the transmitting UE, the receiving UE, or both, may report IDC interference to the network entity, which may avoid the indicated resources for future sidelink grants. The UEs may transmit the IDC interference report to the network entity via RRC signaling during network configuration, UE assistance information, or the two UEs may communicate with each other, and one UE may transmit identified IDC interference to the network entity. In some cases, the IDC interference report may indicate interference affecting specific RATs. In some examples, the UEs may report power co-existence solutions to the network entity.

FIG. 4 illustrates an example of a wireless communications system 400 that supports sidelink IDC interference mitigation in accordance with one or more aspects of the present disclosure. The wireless communications system 400 may implement aspects of, or be implemented by aspects of, the wireless communications system 100 and the wireless communications system 200. For example, the wireless communications system 200 may include one or more UEs 115 (e.g., the UE 115-c and the UE 115-d), which may be examples of corresponding devices described with reference to FIG. 1 and FIG. 2.

In some examples, the UE 115-c and the UE 115-d may communicate with each other via a wireless communication link 405 (e.g., a PC-5 interface). In some examples, a transmitting device (e.g., the UE 115-d) may schedule sidelink resources on which to communicate with the UE 115-c. The sidelink resources may span all or a portion of one or more bands, subbands, channels, or the like (e.g., one or more subchannels, such as subchannel 1, subchannel 2, and subchannel 3). However, the UE 115-c may not be able to receive some or all scheduled transmissions correctly due to IDC interference (e.g., IDC interference 410 as described with reference to FIGS. 2-3). The IDC interference 410 may affect some frequency resources (e.g., at least a portion of subchannel 2 and subchannel 3). The IDC interference 410 may result in failed sidelink transmissions, excessive retransmissions, and in some cases, radio link failure (RLF). Techniques described herein may support reporting and mitigation of IDC interference 410.

For example, a receiving UE (e.g., the UE 115-c) may signal to a transmitting UE (e.g., the UE 115-d) that it is experiencing IDC problems (e.g., the IDC interference 410) at a certain frequency (e.g., in one or more frequency resources). The transmitting UE (e.g., the UE 115-d) may then avoid reserving the IDC affected frequencies for transmissions to the receiving UE (e.g., the UE 115-c). For example, the UE 115-d may indicate that the IDC interference 410 affects a portion or all of the subchannel 2 and a portion or all of the subchannel 3. For example, in cases of unicast signaling, the UE 115-d, or a network entity (e.g., via control signaling, such as mode 2 setup signaling) may configure the receiving UE 115-c to report IDC interference via higher layer signaling (e.g., such as an RRCReconfigurationSidelink message). The higher layer signaling (e.g., an information element of an RRC message) may enable the IDC interference reporting from the receiving UE 115-c. In some examples, the IDC may be added to an RRC message (e.g., the RRCReconfigurationSidelink message) which may include one or more fields. For example, the RRC message may include an assistance message field (e.g., an idc-AssistanceConfig field) including configuration information for the UE 115-c to report assistance information to inform the UE 115-d (e.g., or a network entity) about UE detected IDC problems. The RRC message may include a serving frequency list message (e.g., a candidateServingFreqListNR field) which may indicate for each candidate NR serving cell, a center frequency around which the UE 115-c is requested to report IDC issues. The RRC message may include a resource pool field (e.g., a CandidateResourcePools field) which may indicate resource pools configured for reporting IDC issues. The RRC message may include a subchannel list field (e.g., a CandidateSubchannelList field) that indicates that the UE 115-c is requested to report IDC issues for the configured candidate subchannels (e.g., subchannel 1, subchannel 2, and subchannel 3). The RRC message may include a BWP list message (e.g., a CandidateSLBWPList) that indicates that the UE 115-c is requested to report IDC issues for the configured active or non-active sidelink BWPs. The RRC message may include a granularity message that indicates a granularity of the UE reporting (e.g., indicating whether the UE is to report center frequencies, resource pools, subchannels, BWPs, or other subsets of frequency resources, among other examples, that are experiencing the IDC interference 410).

The granularity of the reporting of IDC interference may be configurable (e.g., by a network entity, a transmitting UE 115-d, or a combination thereof). Configured granularity may indicate that the UE is report IDC interference 410 at a carrier frequency granularity. In such examples, the UE may report that a carrier frequency or a list of carrier frequencies are affected by the IDC frequency sharing problem. The transmitter (e.g., the UE 115-d) may then attempt to transmit sidelink signaling via different carrier frequencies, or may relay deployment reselection to a different UE 115 (e.g., another candidate transmitting UE 115). In some examples, the configured granularity may indicate that the UE is to report IDC interference 410 at a BWP granularity. In such examples, the UE 115-c may report that an entire sidelink BWP (e.g., or a portion of a sidelink BWP) is affected by IDC issues. The transmitting UE 115-d may then attempt to configure different bandwidth parts for mode 2 deployments, or may refrain from sending high quality of service (QoS) traffic via the indicated BWP, or (e.g., for a relay deployment UE) may perform relay reselection.

The configured granularity may indicate that the UE 115-c is to report IDC interference 410 at a sidelink resource pool granularity. In such examples, the UE 115-c may report that the IDC problem is occurring at a certain resource pool. If possible, this may trigger a resource pool reconfiguration. In some examples, the configured granularity may indicate that the UE 115-c is to report IDC interference 410 at a sidelink subchannel granularity. In such examples, the UE 115-c may report the subchannels (e.g., the subchannel 2 and the subchannel 3) affected by the IDC interference 410. The IDC interference report may indicate that the transmitting UE 115-d is to refrain from using the reported subchannels affected by the IDC interference 410. In some examples, the configured granularity may indicate that the UE 115-c is to report IDC interference 410 at a PRB or frequency level of granularity. In such examples, the UE 115-c may report individual PRBs or frequency ranges affected by the IDC interference 410. The transmitting UE 115-d may then refrain from using the resources reported to suffer from IDC issues. As described herein, the UE 115-c may report IDC interference according to any granularity (e.g., may indicate carrier frequencies, sidelink BWPs, sidelink resource pools, sidelink subchannels, sidelink affected PRBs or ranges of frequency resources, among other examples). In some cases, the UE 115-c may report the IDC interference 410 according to a configured granularity.

In some examples (e.g., instead of configuring the IDC reporting as part of a PC5-RRC configuration, such as the various RRC message fields described herein), IDC reporting may be configured as a measurement object. For example, during a measurement configuration provided from the transmitting UE 115-d to the receiving UE 115-d, the transmitting UE 115-d may configure the UE 115-c with a measurement object. In such examples, the UE 115-c may detect (e.g., measure) IDC interference 410, and report it (e.g., if one or more conditions configured via the measuring object are satisfied). In such examples, the UE 115-c may report the IDC interference information via sidelink assistance information (e.g., ueAssistanceInformationSidelink-r17), as a sidelink measurement object, or as an inter-UE coordination information message.

In some examples, the UE 115-c may transmit an IDC interference report to the UE 115-d as part of upper layer signaling (e.g., a PC5 RRC signaling, or a ueAssistanceInformationSidelink-r17 message). In cases of severe IDC issues (e.g., causing RLF), the UE 115-c may indicate the IDC problem in an indication of message (e.g., RRCReconifgurationFailureSidelink message) to prompt the UE 115-d to attempt communication using a different sidelink BWP, different sidelink resource pool, or different sets of frequency resources. In some examples, the UE 115-c may report problematic subchannels (e.g., affected by the IDC interference 410) in UE capability information (e.g., prior to PC-5 RRC establishment procedures). In such examples, the UE 115-c may indicate (e.g., in the capability information) information for prospective transmitters (e.g., prior to any RRC configuration information). In such examples, the UE 115-c may determine resources affected by the IDC interference 410 (e.g., based on current or prior sidelink signaling), and may indicate the affected resources via the capability information. Transmitting UEs 115-d may then avoid the indicated resources for subsequent sidelink communications.

In some examples, IDC interference reporting may be configured as an event-triggered measurement. In such examples, the UE 115-c may transmit a message (e.g., a media access control (MAC) control element (CE)) whenever an IDC problem is encountered. For instance, the UE 115-c may transmit the MAC-CE indicating the existence of IDC interference reporting upon detecting the IDC interference 410 (e.g., upon a channel quality dropping below a threshold due to IDC interference 410, or upon an amount of IDC interference 410 satisfying a threshold).

The UE 115-c may report IDC interference via one or more IDC parameters to indicate the IDC interference. For example, the IDC interference report may include an affected carrier frequency field (e.g., an affectedCarrierFreqList IDC field) that indicates a list of carrier frequencies that are affected by the IDC problem. The IDC interference report may include an affected frequency list field (e.g., an affectedFrequencyList IDC field) that indicates a list of PRBs or frequency ranges that are affected by the IDC problem. The IDC interference report may include an affected subchannel field (e.g., an affectedSubchannelList IDC field) that indicates a list of subchannels that are affected by the IDC problem. The IDC interference report may include an affected resource pool field (e.g., an affectedResourcePoolList IDC field) that indicates a list of carrier frequencies that are affected by the IDC problem. The IDC interference report may include an affected BWP field (e.g., an affectedBWPList IDC field) that indicates a list of sidelink BWPs that are affected by the IDC problem. The IDC interference report may include an affected system type field (e.g., a victimSystemType IDC field) that indicates a list of victim system types to which IDC interference is caused (e.g., by a given RAT). Such a field may indicate a RAT such as GPS, global navigation satellite system (GLONASS), BeiDou Navigation satellite system (BDS), galileo, and navigation with Indian Constellation (NavIC), which may indicate a type of GNSS. Such a field may indicate WLAN or Bluetooth RATs.

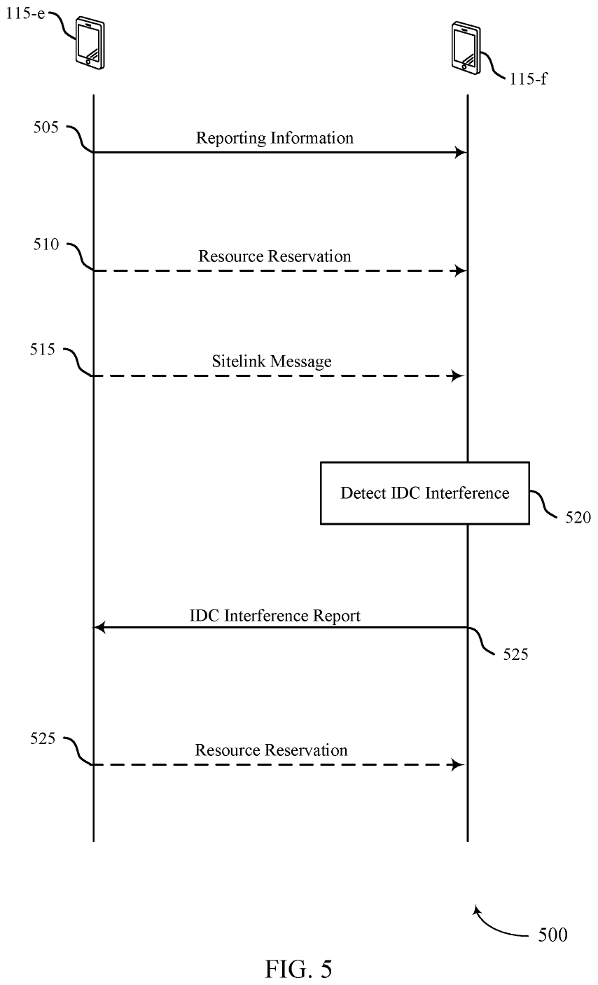

FIG. 5 illustrates an example of a process flow 500 that supports sidelink IDC interference mitigation in accordance with one or more aspects of the present disclosure. The process flow 500 may implement aspects of, or be implemented by, aspects of FIGS. 1-4. For example, the process flow 500 may include a UE 115-e and a UE 115-f, which may be examples of corresponding devices described with reference to FIGS. 1-5.

At 505, the UE 115-f may receive (e.g., from the UE 115-e), reporting information for indicating IDC interference. The reporting information may include sidelink RRC signaling, which may include an indication that the IDC interference reporting by the UE 115-f is enabled. The reporting information may indicate a granularity for reporting IDC interference at 525. For example, the reporting information may indicate a center frequency around which the UE 115-f is requested to report the IDC interference, an indication of a sidelink resource pool for IDC interference, an indication of one or more active sidelink BWPs or inactive sidelink BWPs for corresponding to the IDC interference, or any combination thereof. In some examples, the UE 115-f may receive the reporting information from another device (e.g., another UE 115, or a network entity 105).

In some examples, the reporting information may include a measurement object configuration message, a sidelink information message, an inter-UE coordination information message, etc. The reporting information may include event-triggered measure object configuration information. In such examples, the UE 115-f may detect the IDC interference at 520 (e.g., determine that one or more events or one or more conditions are satisfied), and may transmit the IDC interference report based on being triggered by the detected IDC interference (e.g., the detected event or conditions). In such examples, the UE 115-f may transmit a MAC-CE at 525 including the event-triggered IDC interference report.

At 510, the UE 115-f may receive (e.g., from the UE 115-e, while operating in mode 2) a resource reservation message indicating (e.g., reserving) a set of sidelink resources for performing sidelink communications (e.g., with the UE 115-e).

At 515, the UE 115-e may transmit, to the UE 115-f, a sidelink message. The UE 115-e may transmit the sidelink message via the set of sidelink resources according to the reserve reservation message transmitted at 510.

At 520, the UE 115-f may detect IDC interference (e.g., based on monitoring for the sidelink message transmitted by the UE 115-e at 515 via the resources indicated at 510). For example, the UE 115-f may monitor for the sidelink message, may fail to successfully receive or decode the sidelink message due to IDC interference, may detect the IDC interference based on one or more measurements, or any combination thereof. Based on the monitoring, or the detected failure, the UE 115-f may detect the IDC interference, which the UE 115-f may report at 525.

At 525, the UE 115-f may transmit, to the UE 115-e according to the reporting information, an IDC interference report indicating IDC interference corresponding to at least a portion of the set of sidelink resources allocated at 510. The UE 115-f may transmit, in the IDC interference report, an indication of one or more carrier frequencies, sidelink BWPs, sidelink resource pools, sidelink subchannels, sidelink PRBs, ranges of frequency resources, or any combination thereof, that are affected by the IDC interference (e.g., resources in which the IDC interference is detected, or satisfies a threshold).

In some examples, the IDC interference report may be an indication of link failure associated with the set of sidelink resources due to IDC interference. For example, the IDC interference report may be included in an RLF report.

In some examples, at 525, the UE 115-f may groupcast the IDC interference report to multiple UEs 115 (e.g., including the UE 115-e). The groupcasting of the IDC interference report may support potential transmitters either exclude the reporting UE 115-f from the group, or potential transmitters may avoid indicated resources. Such procedures may allow the network to avoid misinterpreting continuous negative feedback signaling (e.g., negative acknowledgement (NACK) indications) from a group member that severely limits groupcast capacities.

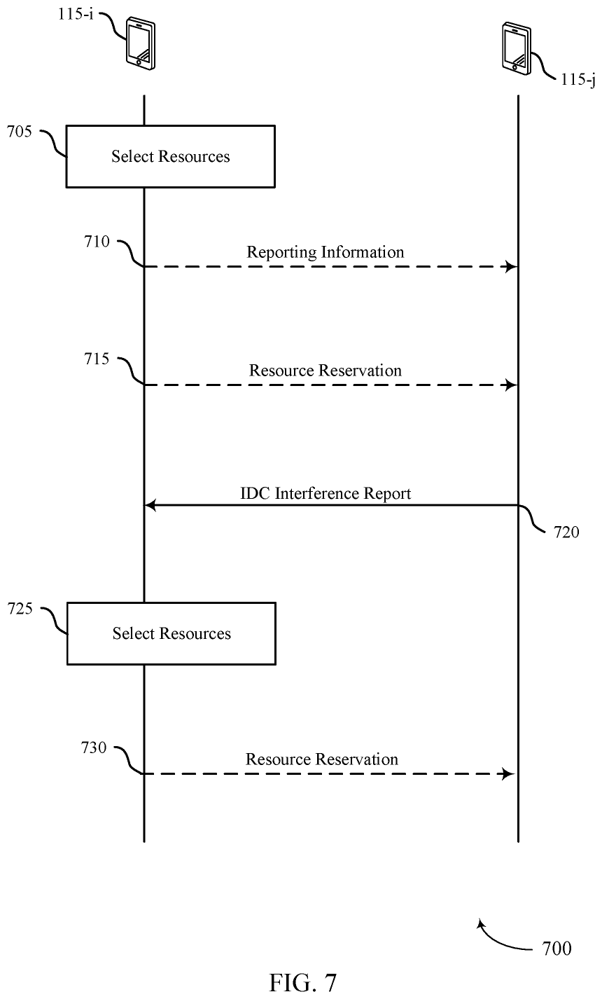

In some examples, the IDC interference report may be an inter-UE coordination message including an indication that the sidelink resources affected by the IDC interference are non-preferred resources (e.g., as described in greater detail with reference to FIG. 7). In some examples, the IDC interference report may be carried via a MAC-CE message, or a sidelink control information (SCI) message (e.g., a SCI format 2-C message).

At 530, the UE 115-e may transmit a resource reservation message to the UE 115-f based on the IDC interference report received from the UE 115-f at 525. For example, the UE 115-e may reserve sidelink resources that are not indicated in the IDC interference report (e.g., sidelink resources that are not impacted by the IDC interference detected at 520). In some examples, the UE 115-e may reserve resources at 510, indicating a first set of resources within a first time period. At 525, based on the IDC interference report 525, the UE 115-e may reserve a second set of resources within a second time period. In some cases, the second time period may not overlap with the first time period (e.g., the second set of resources may be a different set of resources reserved to avoid the frequency resources indicated in the IDC interference report). In some examples, the second time period may overlap at least partially with the first set of resources, in which case the resource reservation message transmitted at 525 may include at least some reselection of resources (e.g., some resources in the second set of resources may override or replace resources reserved at 510 if such resources of the first set of resources are indicated in the IDC interference report).

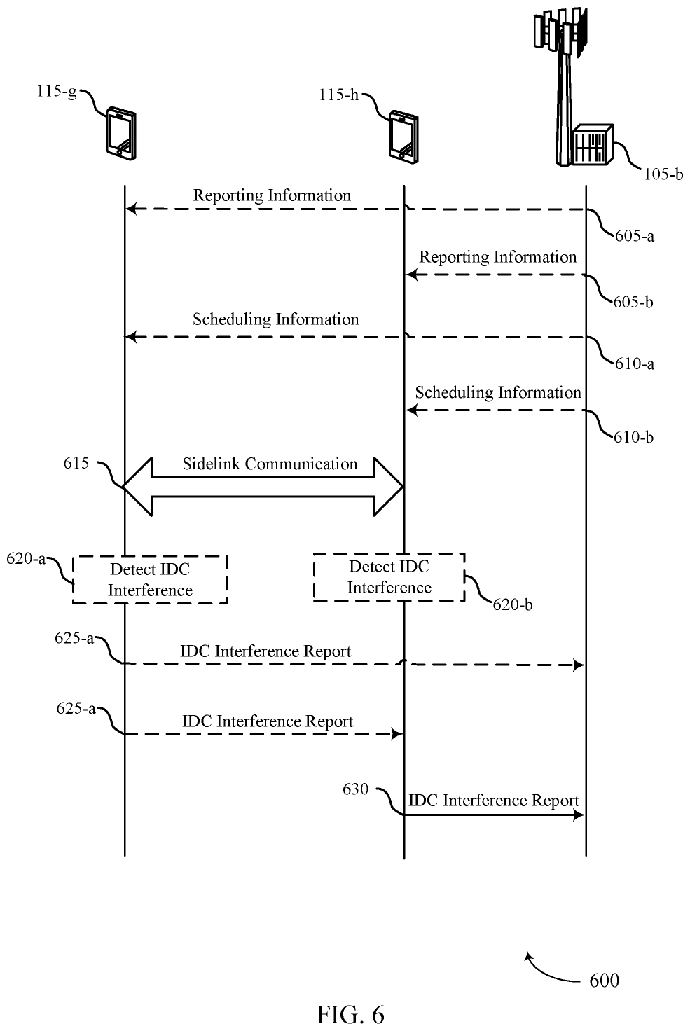

FIG. 6 illustrates an example of a process flow 600 that supports sidelink IDC interference mitigation in accordance with one or more aspects of the present disclosure. The process flow 600 may implement aspects of, or be implemented by, aspects of FIGS. 1-5. For example, the process flow 500 may include a UE 115-e and a UE 115-f, and a network entity 105-b, which may be examples of corresponding devices described with reference to FIGS. 1-5.

The UE 115-h and the UE 115-g may perform sidelink communications while operating according to mode 1. At 610, one or more UEs 115 (e.g., the UE 115-h at 610-a, the UE 115-g at 610-b, or both) may receive (e.g., from the network entity 105-b), scheduling information (e.g., a resource reservation message) indicating a set of sidelink resources for performing sidelink communications.

At 615, the UE 115-g and the UE 115-h may communicate with each other via the sidelink resources indicated at 610. At 620-a, the UE 115-g may detect IDC interference (e.g., based on the sidelink communication at 615).

In some examples, each UE 115 may transmit an IDC interference report indicating IDC interference surrounding to at least a portion of the sidelink resources granted at 610. For instance, both a transmitting UE and a receiving UE may report detected IDC problems happening on sidelink resources (e.g., because the network may be responsible for provisioning resources to the sidelink UEs for the sidelink communication). For example, the UE 115-g may transmit an IDC interference report at 625-a, and the UE 115-h may detect IDC interference at 620-b, and transmit an IDC interference report at 630.

The IDC interference report may be part of a network configuration of PC-5 communication (e.g., may be carried via a sl-ConfigDedicatedNR in an RRCconfiguration message). In some examples, the UE 115-g (e.g., at 605-a), the UE 115-h (e.g., at 605-b), or both, may be configured by the network entity 105-b to transmit the IDC interference reports at 625 and 630, respectively. In some examples, the UE 115-g, the UE 115-h, or both, may transmit the IDC interference report as part of a sidelink UE assistance information message.

In some examples, the IDC reporting information may be reported separately from the transmitter and receiver, or from only one UE 115 (e.g., from the transmitting UE on behalf of both the transmitting UE and the receiving UE). For example, one UE 115 may relay IDC interference reporting to the network entity 105-b (e.g., on behalf of the other UE 115). For example, the UE 115-h may receive (e.g., at 625-a), an indication of the IDC interference, and may transmit the IDC interference report at 630 (e.g., may forward the indication of the IDC interference to the network entity 105-b).

In some examples, the IDC interference report (e.g., transmitted by one or both UEs 115) may indicate that IDC interference associated with the sidelink resources of a first RAT, are impacting wireless communications via a second RAT. For Uu-sidelink intermodulation interference affecting some other RAT, the UE 115-h may report Uu-PC5 band combinations that are causing the IDC issue (e.g., to the network entity 105-b). Such IDC interference reporting may be reported as part of a Uu unified air interface (UAI) indicating interference coming from the sidelink signaling (e.g., the Uu UAI may report assistance form the sidelink, which may or may not be an intermodulation issue). The UE 115-h may transmit the IDC interference reporting information via a PC-5 link, a Uu link, or a combination thereof. In some examples, the UE 115-h, the UE 115-g, or both, may apply FDM power sharing solutions. The UEs 115 may report to the network that a UE 115 has determined to share power to support co-existence. The network entity 105-b may then reassign PC-5 resources to alleviate some IDC issues, or to communicate to another network entity 105-b (e.g., associated with a particular RAT) to coordinate resource sharing in sidelink.

The UE 115-h (e.g., or the UE 115-g) may report IDC interference via one or more IDC parameters to indicate the IDC interference. For example, the IDC interference report may include an affected carrier frequency field (e.g., an affectedCarrierFreqList IDC field or an affected CarrierFreqList) that indicates a list of carrier frequencies that are affected by the IDC problem. The IDC interference report may include an affected frequency list field (e.g., an affectedFrequencyList IDC field) that indicates a list of PRBs or frequency ranges that are affected by the IDC problem. The IDC interference report may include an affected subchannel field (e.g., an affectedSubchannelList IDC field) that indicates a list of subchannels that are affected by the IDC problem. The IDC interference report may include an affected resource pool field (e.g., an affectedResourcePoolList IDC field) that indicates a list of carrier frequencies that are affected by the IDC problem. The IDC interference report may include an affected BWP field (e.g., an affectedBWPList IDC field) that indicates a list of sidelink BWPs that are affected by the IDC problem. The IDC interference report may include an affected system type field (e.g., a victimSystemType IDC field) that indicates a list of victim system types to which IDC interference is caused (e.g., by a given RAT). Such a field may indicate a RAT such as GPS, GLONASS, BDS, galileo, and NavIC, which may indicate a type of GNSS. Such a field may indicate WLAN or Bluetooth RATs. The IDC interference report may include an interference direction (e.g., an interferenceDirection IDC field) that indicates a direction of IDC interference. A value of “PC5” may indicate that only PC-5 signaling is a victim of IDC interference, a value of “other” may indicate that only another radio is victim to IDC interference, and a value of “both” my indicate that both PC-5 and another radio are victims of IDC interference. Other radios may refer to one or multiple RATs.

FIG. 7 illustrates an example of a process flow 700 that supports sidelink IDC interference mitigation in accordance with one or more aspects of the present disclosure. The process flow 700 may implement aspects of, or be implemented by, aspects of FIGS. 1-6. For example, the process flow 700 may include a UE 115-i and a UE 115-j, which may be examples of corresponding devices described with reference to FIGS. 1-6.

At 705, the UE 115-i may select resources to allocate to the UE 115-j (e.g., when the UE 115-i and the UE 115-j are operating in Mode 2).

At 710, the UE 115-j may receive (e.g., from the UE 115-i), reporting information for indicating IDC interference. The reporting information may include configuration information for transmitting an indication of non-preferred resources (e.g., an IDC interference report).

At 715, the UE 115-j may receive (e.g., from the UE 115-i, while operating in mode 2) a resource reservation message indicating (e.g., reserving) a set of sidelink resources for performing sidelink communications (e.g., with the UE 115-i). The UE 115-j may detect IDC interference (e.g., while communicating with the UE 115-e via the resources indicated at or prior to any sidelink communications with the UE 115-i).

At 720, the UE 115-j may transmit, to the UE 115-i, an IDC interference report indicating IDC interference corresponding to at least a portion of a set of sidelink resources. The IDC interference report may be an inter-UE coordination information message to indicate a set of preferred sidelink resources (e.g., resources that are not currently or are less likely to be impacted by IDC interference) or non-preferred (e.g., un-preferred) sidelink resources (e.g., resources that are currently or are likely to be impacted by IDC interference). In some examples, the UE 115-j may perform proactive IDC interference reporting. For example, the receiving UE 115-j may transmit the IDC interference report at 720 (e.g., prior to resource reservation at 730, and without previous resource reservation occurring at 715). In such examples, the UE 115-j may indicate non-preferred sidelink resources, and the UE 115-i may select sidelink resources at 725 and reserve the selected sidelink resources at 730 to avoid the non-preferred sidelink resources indicated at 720. In some examples, the UE 115-j may perform reactive IDC interference reporting. For example, based on receiving the resource reservation at 715, the UE 115-j may determine that some indicated or granted sidelink resources are impacted by IDC interference (e.g., and are therefore non-preferred resources). In response, the UE 115-j may transmit the IDC interference report at 720 (e.g., an inter-UE coordination message indicating the non-preferred resources). At 725, the UE 115-i may select sidelink resources (e.g., may perform sidelink resources reselection) to avoid the non-preferred resources and may indicate the updated resource reservation at 730.

Non-preferred resources (e.g., as indicated in the IDC interference report) may be defined as sidelink resources that satisfy one or more conditions. For example, a non-preferred resource may be a resource reserved by another UE with either an RSRP measuring that satisfies or is above a threshold (e.g., protecting the reporting UE, or the transmitting UE, from interference by other UEs 115), or an RARP measurement below a threshold where the reporting UE is the intended recipient of a transmission via the reserved resources (e.g., protecting the reporting UE reception from interference by another UE). Non-preferred resources may be resources in a slot where the reporting UE 115-j cannot receive a transmission from the transmitting UE 115-i due to half-duplex deployment. A non-preferred resource may only overlap with frequencies affected internally by IDC interference. A non-preferred resource set may include frequency resources only (e.g., indicated by a frequency resource indication value (FRIV)), and a time resource indication value (TRIV) may be used to indicate other IDC parameters (e.g., such as the various IDC fields described herein).

In some examples, the IDC interference report (e.g., indicating the non-preferred resources) may be unicast, multicast, groupcast, or broadcast. Triggering of transmission of the IDC interference report may include a request from the transmitting UE 115-i (e.g., the reporting information transmitting at 710 may include a request to transmit the IDC interference report (e.g., the inter-UE coordination message) indicating the non-preferred resources).In some examples, the request (e.g., the reporting information) may be transmitted via sidelink control information (e.g., SCI 2 or SCI format 2-C) or a MAC-CE. The resource set (e.g., the resource reservation at 715, or the resources indicated in the IDC interference report) may be transmitted as an SCI2 message (e.g., SCI carried via a physical sidelink shared channel (PSSCH)) or a MAC-CE. In some examples, the transmitting UE 115-i may transmit (e.g., via reporting information at 710) capability information indicating that the UE 115-i is capable of using IDC interference information (e.g., to select or reselect resources at 725) via an SCI message. The UE 115-i may forward the IDC indication (e.g., the IDC interference report) from the physical layer to the MAC layer if received via SCI signaling. In some examples, the UE 115-j may transmit the IDC interference report based on a request or based on one or more conditions. The conditions may be configured via PC-5 RRC signaling, or may be pre-configured, indicated in one or more standard s documents, among other examples. If the conditions are satisfied, the UE 115-j may transmit the IDC interference report. In some examples, non-preferred resources due to IDC interference may be reported together with other non-preferred resources (e.g., a set of non-preferred resources of which a subset are non-preferred based on the IDC interference) or may be reported separately with a clarification (e.g., an indication) of which resources are non-preferred specifically because of IDC interference.

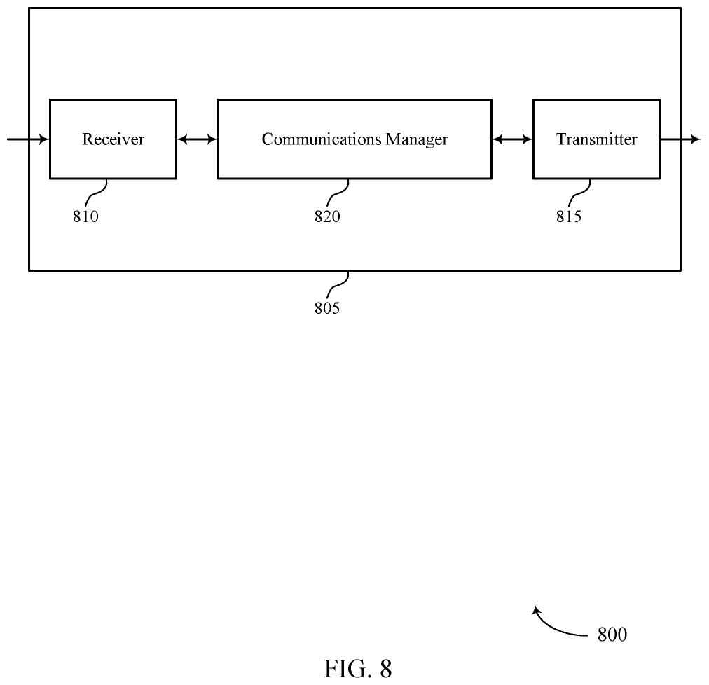

FIG. 8 illustrates a block diagram 800 of a device 805 that supports sidelink IDC interference mitigation in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to sidelink IDC interference mitigation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to sidelink IDC interference mitigation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of sidelink IDC interference mitigation as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a first UE in accordance with examples as disclosed herein. For example, the communications manager 820 may be configured as or otherwise support a means for receiving, from a second UE, reporting information for indicating IDC interference. The communications manager 820 may be configured as or otherwise support a means for receiving, from the second UE, a resource reservation message indicating a set of sidelink resources. The communications manager 820 may be configured as or otherwise support a means for transmitting, to the second UE according to the reporting information, an IDC interference report indicating IDC interference corresponding to at least a portion of the set of sidelink resources.

Additionally, or alternatively, the communications manager 820 may support wireless communications at a first UE in accordance with examples as disclosed herein. For example, the communications manager 820 may be configured as or otherwise support a means for receiving, from a network entity, a resource reservation message indicating a set of sidelink resources for performing sidelink communications with at least a second UE. The communications manager 820 may be configured as or otherwise support a means for communicating with the second UE according to the resource reservation message. The communications manager 820 may be configured as or otherwise support a means for transmitting, to the network entity based on performing the sidelink communications, an IDC interference report indicating IDC interference corresponding to at least a portion of the set of sidelink resources.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for IDC interference reporting and mitigation, resulting in decreased system latency, more reliable signaling, and improved user experience.

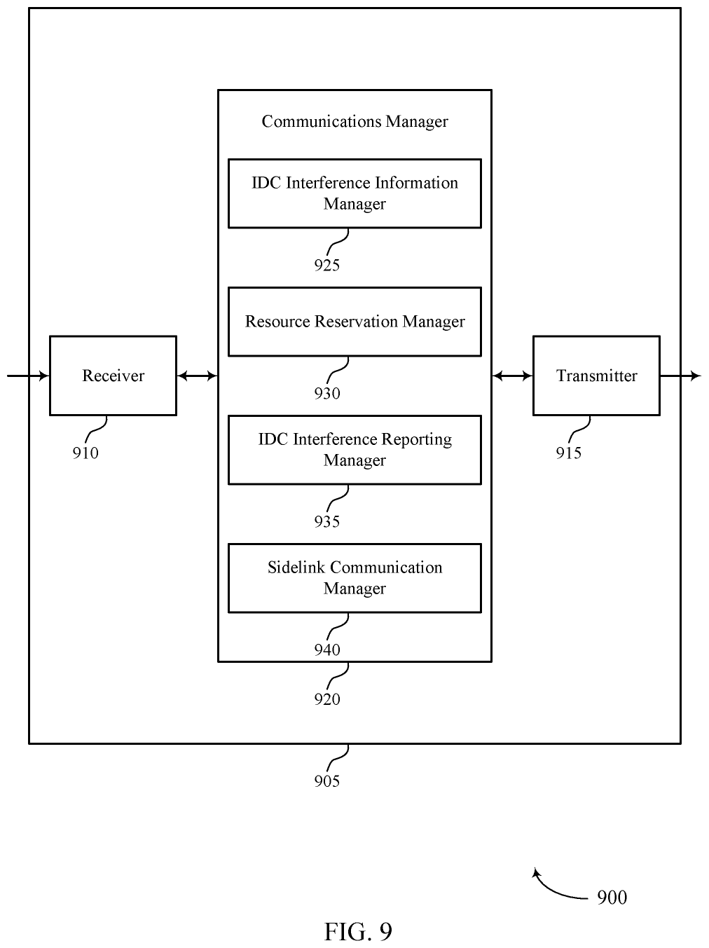

FIG. 9 illustrates a block diagram 900 of a device 905 that supports sidelink IDC interference mitigation in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to sidelink IDC interference mitigation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sidelink IDC interference mitigation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of sidelink IDC interference mitigation as described herein. For example, the communications manager 920 may include an IDC interference information manager 925, a resource reservation manager 930, an IDC interference reporting manager 935, a sidelink communication manager 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first UE in accordance with examples as disclosed herein. The IDC interference information manager 925 may be configured as or otherwise support a means for receiving, from a second UE, reporting information for indicating IDC interference. The resource reservation manager 930 may be configured as or otherwise support a means for receiving, from the second UE, a resource reservation message indicating a set of sidelink resources. The IDC interference reporting manager 935 may be configured as or otherwise support a means for transmitting, to the second UE according to the reporting information, an IDC interference report indicating IDC interference corresponding to at least a portion of the set of sidelink resources.

Additionally, or alternatively, the communications manager 920 may support wireless communications at a first UE in accordance with examples as disclosed herein. The resource reservation manager 930 may be configured as or otherwise support a means for receiving, from a network entity, a resource reservation message indicating a set of sidelink resources for performing sidelink communications with at least a second UE. The sidelink communication manager 940 may be configured as or otherwise support a means for communicating with the second UE according to the resource reservation message. The IDC interference reporting manager 935 may be configured as or otherwise support a means for transmitting, to the network entity based on performing the sidelink communications, an IDC interference report indicating IDC interference corresponding to at least a portion of the set of sidelink resources.

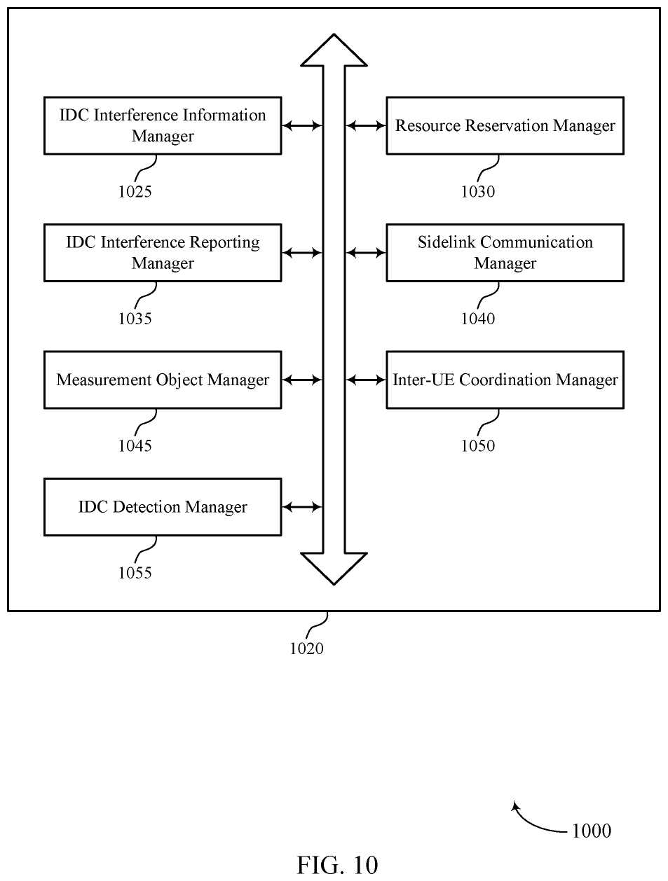

FIG. 10 illustrates a block diagram 1000 of a communications manager 1020 that supports sidelink IDC interference mitigation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of sidelink IDC interference mitigation as described herein. For example, the communications manager 1020 may include an IDC interference information manager 1025, a resource reservation manager 1030, an IDC interference reporting manager 1035, a sidelink communication manager 1040, a measurement object manager 1045, an inter-UE coordination manager 1050, an IDC detection manager 1055, or any combination thereof. Each of these components may communicate, directly or indirectly, with one another (e.g., via one or more buses).

The communications manager 1020 may support wireless communications at a first UE in accordance with examples as disclosed herein. The IDC interference information manager 1025 may be configured as or otherwise support a means for receiving, from a second UE, reporting information for indicating IDC interference. The resource reservation manager 1030 may be configured as or otherwise support a means for receiving, from the second UE, a resource reservation message indicating a set of sidelink resources. The IDC interference reporting manager 1035 may be configured as or otherwise support a means for transmitting, to the second UE according to the reporting information, an IDC interference report indicating IDC interference corresponding to at least a portion of the set of sidelink resources.

In some examples, to support receiving the reporting information, the IDC interference information manager 1025 may be configured as or otherwise support a means for receiving sidelink RRC signaling including the reporting information, where the reporting information includes an indication that IDC interference reporting by the first UE is enabled.

In some examples, the IDC interference information manager 1025 may be configured as or otherwise support a means for receiving, in the sidelink RRC signaling, an indication of a center frequency around which the first UE is requested to report the IDC interference, an indication of a sidelink resource pool for reporting the IDC, an indication of one or more subchannels associated with reporting the IDC, an indication of one or more active sidelink bandwidth parts or inactive sidelink bandwidth parts for corresponding to the IDC, or any combination thereof.

In some examples, to support receiving the reporting information, the IDC interference information manager 1025 may be configured as or otherwise support a means for receiving a measurement object configuration message, a sidelink assistance information message or an inter-UE coordination information message.

In some examples, the IDC interference reporting manager 1035 may be configured as or otherwise support a means for transmitting, in the IDC interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by the IDC interference.

In some examples, to support transmitting the IDC interference report, the IDC interference reporting manager 1035 may be configured as or otherwise support a means for transmitting an indication of a link failure associated with the set of sidelink resources due to the IDC interference.

In some examples, the measurement object manager 1045 may be configured as or otherwise support a means for receiving, in the reporting information, event-triggered measurement object configuration. In some examples, the measurement object manager 1045 may be configured as or otherwise support a means for detecting the IDC interference based on monitoring the set of sidelink resources in accordance with the event-triggered measurement object configuration, where transmitting the IDC interference report includes transmitting a MAC control element (CE) based on detecting the IDC interference.

In some examples, to support transmitting the IDC interference report, the IDC interference reporting manager 1035 may be configured as or otherwise support a means for groupcasting the IDC interference report to a set of multiple sidelink UEs including the second UE.

In some examples, to support transmitting the IDC interference report, the inter-UE coordination manager 1050 may be configured as or otherwise support a means for transmitting an inter-UE coordination message including an indication that a set of multiple sidelink resources including at least the portion of the set of sidelink resources are non-preferred resources.

In some examples, the inter-UE coordination manager 1050 may be configured as or otherwise support a means for receiving, from the second UE, a request for an indication of non-preferred resources, where transmitting the inter-UE coordination message is based on receiving the request.

In some examples, the inter-UE coordination manager 1050 may be configured as or otherwise support a means for receiving configuration information indication one or more conditions, where transmitting the inter-UE coordination message is based on the one or more conditions being satisfied.

In some examples, the inter-UE coordination manager 1050 may be configured as or otherwise support a means for receiving, from the second UE, an indication that the second UE is capable of receiving the inter-UE coordination message, where transmitting the inter-UE coordination message is based on receiving the indication that the second UE is capable of receiving the inter-UE coordination message.

In some examples, the inter-UE coordination manager 1050 may be configured as or otherwise support a means for transmitting, in the inter-UE coordination message, an indication of a first subset of the set of multiple sidelink resources that are non-preferred due to IDC interference.

In some examples, the IDC detection manager 1055 may be configured as or otherwise support a means for monitoring for sidelink signaling from the second UE based on the resource reservation message. In some examples, the IDC detection manager 1055 may be configured as or otherwise support a means for detecting the IDC interference on at least the portion of the set of sidelink resources based on the monitoring, where transmitting the IDC interference report is based on detecting the IDC interference.

Additionally, or alternatively, the communications manager 1020 may support wireless communications at a first UE in accordance with examples as disclosed herein. In some examples, the resource reservation manager 1030 may be configured as or otherwise support a means for receiving, from a network entity, a resource reservation message indicating a set of sidelink resources for performing sidelink communications with at least a second UE. The sidelink communication manager 1040 may be configured as or otherwise support a means for communicating with the second UE according to the resource reservation message. In some examples, the IDC interference reporting manager 1035 may be configured as or otherwise support a means for transmitting, to the network entity based on performing the sidelink communications, an IDC interference report indicating IDC interference corresponding to at least a portion of the set of sidelink resources.

In some examples, to support transmitting the IDC interference report, the IDC interference reporting manager 1035 may be configured as or otherwise support a means for transmitting a RRC message including an indication of at least the portion of the set of sidelink resources experiencing the IDC interference.

In some examples, to support transmitting the IDC interference report, the IDC interference reporting manager 1035 may be configured as or otherwise support a means for transmitting a UE assistance information message including an indication of at least the portion of the set of sidelink resources experiencing the IDC interference.

In some examples, the IDC interference reporting manager 1035 may be configured as or otherwise support a means for receiving, from the second UE, an indication of the IDC interference, where transmitting the IDC interference report includes forwarding the indication of the IDC interference to the network entity.

In some examples, to support transmitting the IDC interference report, the IDC interference reporting manager 1035 may be configured as or otherwise support a means for transmitting an indication of the IDC interference associated with the set of sidelink resources of a first radio access technology impacting wireless communications via a second radio access technology.

In some examples, the IDC interference reporting manager 1035 may be configured as or otherwise support a means for transmitting, in the IDC interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by IDC interference.

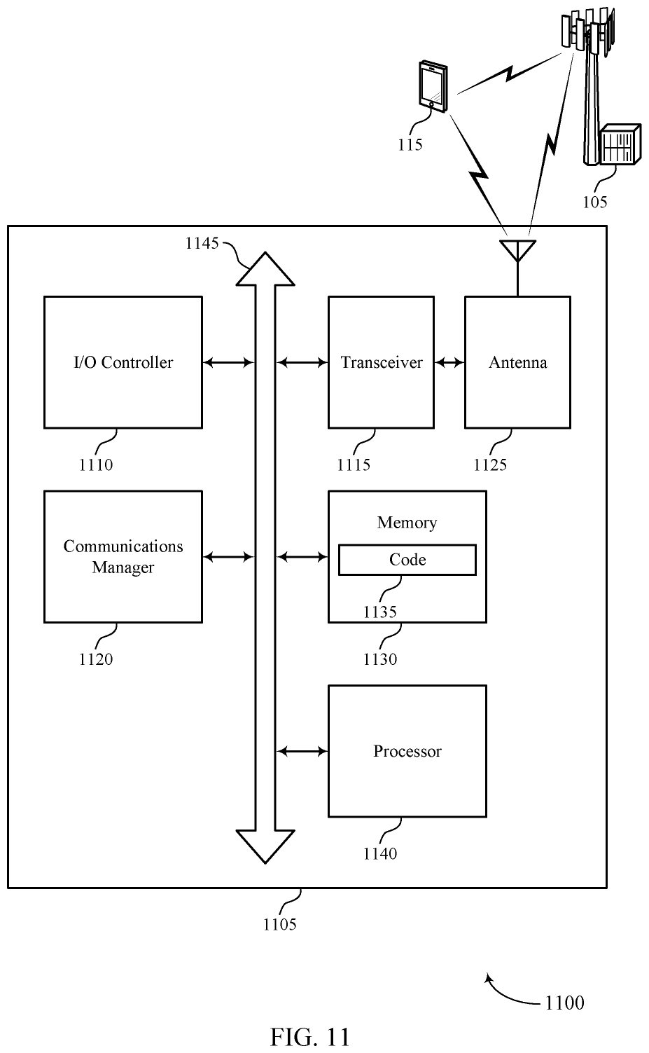

FIG. 11 illustrates a diagram of a system 1100 including a device 1105 that supports sidelink IDC interference mitigation in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting sidelink IDC interference mitigation). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a first UE in accordance with examples as disclosed herein. For example, the communications manager 1120 may be configured as or otherwise support a means for receiving, from a second UE, reporting information for indicating IDC interference. The communications manager 1120 may be configured as or otherwise support a means for receiving, from the second UE, a resource reservation message indicating a set of sidelink resources. The communications manager 1120 may be configured as or otherwise support a means for transmitting, to the second UE according to the reporting information, an IDC interference report indicating IDC interference corresponding to at least a portion of the set of sidelink resources.

Additionally, or alternatively, the communications manager 1120 may support wireless communications at a first UE in accordance with examples as disclosed herein. For example, the communications manager 1120 may be configured as or otherwise support a means for receiving, from a network entity, a resource reservation message indicating a set of sidelink resources for performing sidelink communications with at least a second UE. The communications manager 1120 may be configured as or otherwise support a means for communicating with the second UE according to the resource reservation message. The communications manager 1120 may be configured as or otherwise support a means for transmitting, to the network entity based on performing the sidelink communications, an IDC interference report indicating IDC interference corresponding to at least a portion of the set of sidelink resources.

By including or configuring the communications manager 1120 in accordance with examples as described herein, the device 1105 may support techniques for IDC interference reporting and mitigation resulting in improved communication reliability, reduced system latency, improved user experience, reduced signaling overhead, and improved user experience.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of sidelink IDC interference mitigation as described herein, or the processor 1140 and the memory 1130 may be otherwise configured to perform or support such operations.

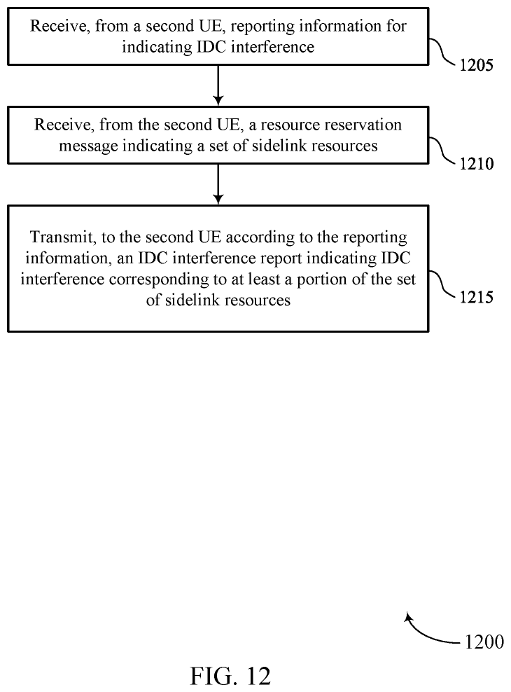

FIG. 12 illustrates a flowchart showing a method 1200 that supports sidelink IDC interference mitigation in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving, from a second UE, reporting information for indicating IDC interference. The operations of 1205 may be performed in accordance with examples as disclosed herein. In some examples, aspects of the operations of 1205 may be performed by an IDC interference information manager 1025 as described with reference to FIG. 10.

At 1210, the method may include receiving, from the second UE, a resource reservation message indicating a set of sidelink resources. The operations of 1210 may be performed in accordance with examples as disclosed herein. In some examples, aspects of the operations of 1210 may be performed by a resource reservation manager 1030 as described with reference to FIG. 10.

At 1215, the method may include transmitting, to the second UE according to the reporting information, an IDC interference report indicating IDC interference corresponding to at least a portion of the set of sidelink resources. The operations of 1215 may be performed in accordance with examples as disclosed herein. In some examples, aspects of the operations of 1215 may be performed by an IDC interference reporting manager 1035 as described with reference to FIG. 10.

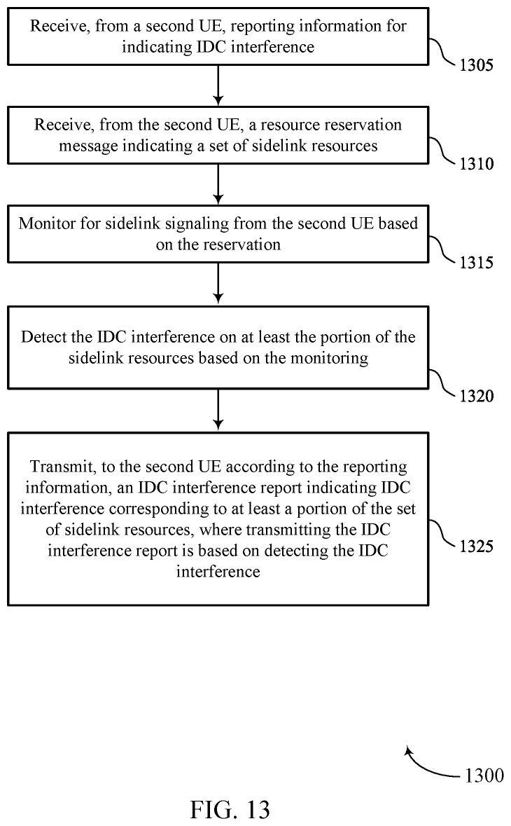

FIG. 13 illustrates a flowchart showing a method 1300 that supports sidelink IDC interference mitigation in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving, from a second UE, reporting information for indicating IDC interference. The operations of 1305 may be performed in accordance with examples as disclosed herein. In some examples, aspects of the operations of 1305 may be performed by an IDC interference information manager 1025 as described with reference to FIG. 10.

At 1310, the method may include receiving, from the second UE, a resource reservation message indicating a set of sidelink resources. The operations of 1310 may be performed in accordance with examples as disclosed herein. In some examples, aspects of the operations of 1310 may be performed by a resource reservation manager 1030 as described with reference to FIG. 10.

At 1315, the method may include monitoring for sidelink signaling from the second UE based on the resource reservation message. The operations of 1315 may be performed in accordance with examples as disclosed herein. In some examples, aspects of the operations of 1315 may be performed by an IDC detection manager 1055 as described with reference to FIG. 10.

At 1320, the method may include detecting the IDC interference on at least the portion of the set of sidelink resources based on the monitoring. The operations of 1320 may be performed in accordance with examples as disclosed herein. In some examples, aspects of the operations of 1320 may be performed by an IDC detection manager 1055 as described with reference to FIG. 10.

At 1325, the method may include transmitting, to the second UE according to the reporting information, an IDC interference report indicating IDC interference corresponding to at least a portion of the set of sidelink resources, where transmitting the IDC interference report is based on detecting the IDC interference. The operations of 1325 may be performed in accordance with examples as disclosed herein. In some examples, aspects of the operations of 1325 may be performed by an IDC interference reporting manager 1035 as described with reference to FIG. 10.

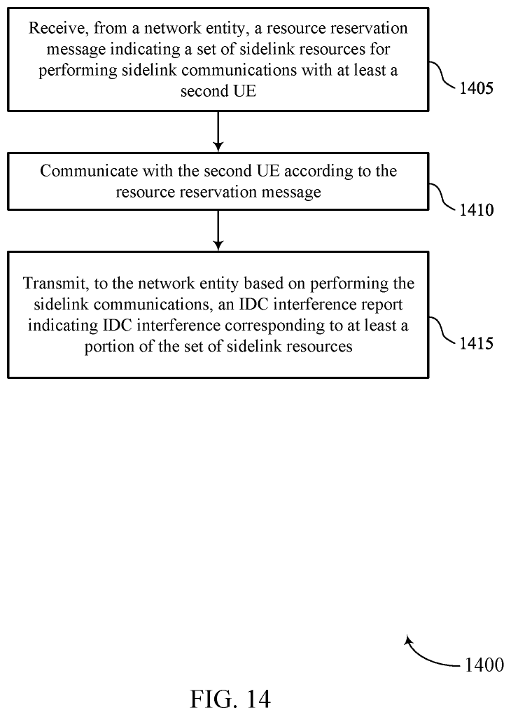

FIG. 14 illustrates a flowchart showing a method 1400 that supports sidelink IDC interference mitigation in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a resource reservation message indicating a set of sidelink resources for performing sidelink communications with at least a second UE. The operations of 1405 may be performed in accordance with examples as disclosed herein. In some examples, aspects of the operations of 1405 may be performed by a resource reservation manager 1030 as described with reference to FIG. 10.

At 1410, the method may include communicating with the second UE according to the resource reservation message. The operations of 1410 may be performed in accordance with examples as disclosed herein. In some examples, aspects of the operations of 1410 may be performed by a sidelink communication manager 1040 as described with reference to FIG. 10.

At 1415, the method may include transmitting, to the network entity based on performing the sidelink communications, an IDC interference report indicating IDC interference corresponding to at least a portion of the set of sidelink resources. The operations of 1415 may be performed in accordance with examples as disclosed herein. In some examples, aspects of the operations of 1415 may be performed by an IDC interference reporting manager 1035 as described with reference to FIG. 10.

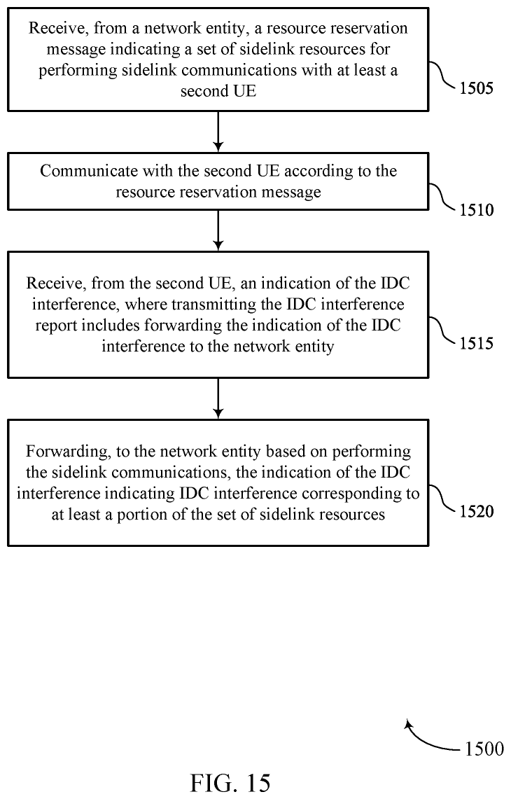

FIG. 15 illustrates a flowchart showing a method 1500 that supports sidelink IDC interference mitigation in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a resource reservation message indicating a set of sidelink resources for performing sidelink communications with at least a second UE. The operations of 1505 may be performed in accordance with examples as disclosed herein. In some examples, aspects of the operations of 1505 may be performed by a resource reservation manager 1030 as described with reference to FIG. 10.

At 1510, the method may include communicating with the second UE according to the resource reservation message. The operations of 1510 may be performed in accordance with examples as disclosed herein. In some examples, aspects of the operations of 1510 may be performed by a sidelink communication manager 1040 as described with reference to FIG. 10.

At 1515, the method may include receiving, from the second UE, an indication of the IDC interference, where transmitting the IDC interference report includes forwarding the indication of the IDC interference to the network entity. The operations of 1515 may be performed in accordance with examples as disclosed herein. In some examples, aspects of the operations of 1515 may be performed by an IDC interference reporting manager 1035 as described with reference to FIG. 10.

At 1520, the method may include forwarding, to the network entity based on performing the sidelink communications, the indication of the IDC interference indicating IDC interference corresponding to at least a portion of the set of sidelink resources. The operations of 1520 may be performed in accordance with examples as disclosed herein. In some examples, aspects of the operations of 1520 may be performed by an IDC interference reporting manager 1035 as described with reference to FIG. 10.

The following provides an overview of aspects of the present disclosure:

Aspect 1: A method for wireless communications at a first UE, comprising: receiving, from a second UE, reporting information for indicating in-device co-existence interference; receiving, from the second UE, a resource reservation message indicating a set of sidelink resources; and transmitting, to the second UE according to the reporting information, an in-device co-existence interference report indicating in-device co-existence interference corresponding to at least a portion of the set of sidelink resources.

Aspect 2: The method of aspect 1, wherein receiving the reporting information comprises: receiving sidelink RRC signaling comprising the reporting information, wherein the reporting information comprises an indication that in-device co-existence interference reporting by the first UE is enabled.

Aspect 3: The method of aspect 2, further comprising: receiving, in the sidelink RRC signaling, an indication of a center frequency around which the first UE is requested to report the in-device co-existence interference, an indication of a sidelink resource pool for reporting the in-device co-existence interference, an indication of one or more subchannels associated with reporting the in-device co-existence interference, an indication of one or more active sidelink bandwidth parts or inactive sidelink bandwidth parts for corresponding to the in-device co-existence interference, or any combination thereof.

Aspect 4: The method of any of aspects 1 through 3, wherein receiving the reporting information comprises: receiving a measurement object configuration message, a sidelink assistance information message or an inter-UE coordination information message.

Aspect 5: The method of any of aspects 1 through 4, further comprising: transmitting, in the in-device co-existence interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by the in-device co-existence interference.

Aspect 6: The method of any of aspects 1 through 5, wherein transmitting the in-device co-existence interference report comprises: transmitting an indication of a link failure associated with the set of sidelink resources due to the in-device co-existence interference.

Aspect 7: The method of any of aspects 1 through 6, further comprising: receiving, in the reporting information, event-triggered measurement object configuration; and detecting the in-device co-existence interference based at least in part on monitoring the set of sidelink resources in accordance with the even-triggered measurement object configuration, wherein transmitting the in-device co-existence interference report comprises transmitting a MAC control element (CE) based at least in part on detecting the in-device co-existence interference.

Aspect 8: The method of any of aspects 1 through 7, wherein transmitting the in-device co-existence interference report comprises: groupcasting the in-device co-existence interference report to a plurality of sidelink UEs comprising the second UE.

Aspect 9: The method of any of aspects 1 through 8, wherein transmitting the in-device co-existence interference report comprises: transmitting an inter-UE coordination message comprising an indication that a plurality of sidelink resources comprising at least the portion of the set of sidelink resources are non-preferred resources.

Aspect 10: The method of aspect 9, further comprising: receiving, from the second UE, a request for an indication of non-preferred resources, wherein transmitting the inter-UE coordination message is based at least in part on receiving the request.

Aspect 11: The method of any of aspects 9 through 10, further comprising: receiving configuration information indication one or more conditions, wherein transmitting the inter-UE coordination message is based at least in part on the one or more conditions being satisfied.

Aspect 12: The method of any of aspects 9 through 11, further comprising: receiving, from the second UE, an indication that the second UE is capable of receiving the inter-UE coordination message, wherein transmitting the inter-UE coordination message is based at least in part on receiving the indication that the second UE is capable of receiving the inter-UE coordination message.

Aspect 13: The method of any of aspects 9 through 12, further comprising: transmitting, in the inter-UE coordination message, an indication of a first subset of the plurality of sidelink resources that are non-preferred due to in-device co-existence interference.

Aspect 14: The method of any of aspects 1 through 13, further comprising: monitoring for sidelink signaling from the second UE based at least in part on the resource reservation message; and detecting the in-device co-existence interference on at least the portion of the set of sidelink resources based at least in part on the monitoring, wherein transmitting the in-device co-existence interference report is based at least in part on detecting the in-device co-existence interference.

Aspect 15: A method for wireless communications at a first UE, comprising: receiving, from a network entity, a resource reservation message indicating a set of sidelink resources for performing sidelink communications with at least a second UE; communicating with the second UE according to the resource reservation message; and transmitting, to the network entity based at least in part on performing the sidelink communications, an in-device co-existence interference report indicating in-device co-existence interference corresponding to at least a portion of the set of sidelink resources.

Aspect 16: The method of aspect 15, wherein transmitting the in-device co-existence interference report comprises: transmitting a radio resource control message comprising an indication of at least the portion of the set of sidelink resources experiencing the in-device co-existence interference.

Aspect 17: The method of any of aspects 15 through 16, wherein transmitting the in-device co-existence interference report comprises: transmitting a UE assistance information message comprising an indication of at least the portion of the set of sidelink resources experiencing the in-device co-existence interference.

Aspect 18: The method of any of aspects 15 through 17, further comprising: receiving, from the second UE, an indication of the in-device co-existence interference, wherein transmitting the in-device co-existence interference report comprises forwarding the indication of the in-device co-existence interference to the network entity.

Aspect 19: The method of any of aspects 15 through 18, wherein transmitting the in-device co-existence interference report comprises: transmitting an indication of the in-device co-existence interference associated with the set of sidelink resources of a first radio access technology impacting wireless communications via a second radio access technology.

Aspect 20: The method of any of aspects 15 through 19, further comprising: transmitting, in the in-device co-existence interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by in-device co-existence interference.

Aspect 21: An apparatus for wireless communications at a first UE, comprising a processor; memory coupled with the processor; and instructions stored in the memory and executable by the processor to cause the apparatus to perform a method of any of aspects 1 through 14.

Aspect 22: An apparatus for wireless communications at a first UE, comprising at least one means for performing a method of any of aspects 1 through 14.

Aspect 23: A non-transitory computer-readable medium storing code for wireless communications at a first UE, the code comprising instructions executable by a processor to perform a method of any of aspects 1 through 14.

Aspect 24: An apparatus for wireless communications at a first UE, comprising a processor; memory coupled with the processor; and instructions stored in the memory and executable by the processor to cause the apparatus to perform a method of any of aspects 15 through 20.

Aspect 25: An apparatus for wireless communications at a first UE, comprising at least one means for performing a method of any of aspects 15 through 20.

Aspect 26: A non-transitory computer-readable medium storing code for wireless communications at a first UE, the code comprising instructions executable by a processor to perform a method of any of aspects 15 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
a processor;
memory coupled with the processor; and
instructions stored in the memory and executable by the processor to cause the apparatus to:
receive, from a second UE, reporting information for indicating in-device co-existence interference;
receive, from the second UE, a resource reservation message indicating a set of sidelink resources; and
transmit, to the second UE according to the reporting information, an in-device co-existence interference report indicating in-device co-existence interference corresponding to at least a portion of the set of sidelink resources.

2. The apparatus of claim 1, wherein the instructions to receive the reporting information are executable by the processor to cause the apparatus to:
receive sidelink radio resource control signaling comprising the reporting information, wherein the reporting information comprises an indication that in-device co-existence interference reporting by the first UE is enabled.

3. The apparatus of claim 2, wherein the instructions are further executable by the processor to cause the apparatus to:
receive, in the sidelink radio resource control signaling, an indication of a center frequency around which the first UE is requested to report the in-device co-existence interference, an indication of a sidelink resource pool for reporting the in-device co-existence interference, an indication of one or more subchannels associated with reporting the in-device co-existence interference, an indication of one or more active sidelink bandwidth parts or inactive sidelink bandwidth parts for corresponding to the in-device co-existence interference, or any combination thereof.

4. The apparatus of claim 1, wherein the instructions to receive the reporting information are executable by the processor to cause the apparatus to:
receive a measurement object configuration message, a sidelink assistance information message or an inter-UE coordination information message.

5. The apparatus of claim 1, wherein the instructions are further executable by the processor to cause the apparatus to:
transmit, in the in-device co-existence interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by the in-device co-existence interference.

6. The apparatus of claim 1, wherein the instructions to transmit the in-device co-existence interference report are executable by the processor to cause the apparatus to:
transmit an indication of a link failure associated with the set of sidelink resources due to the in-device co-existence interference.

7. The apparatus of claim 1, wherein the instructions are further executable by the processor to cause the apparatus to:
receive, in the reporting information, event-triggered measurement object configuration; and
detect the in-device co-existence interference based at least in part on monitoring the set of sidelink resources in accordance with the event-triggered measurement object configuration, wherein transmitting the in-device co-existence interference report comprises transmitting a media access control (MAC) control element (CE) based at least in part on detecting the in-device co-existence interference.

8. The apparatus of claim 1, wherein the instructions to transmit the in-device co-existence interference report are executable by the processor to cause the apparatus to:
groupcast the in-device co-existence interference report to a plurality of sidelink UEs comprising the second UE.

9. The apparatus of claim 1, wherein the instructions to transmit the in-device co-existence interference report are executable by the processor to cause the apparatus to:
transmit an inter-UE coordination message comprising an indication that a plurality of sidelink resources comprising at least the portion of the set of sidelink resources are non-preferred resources.

10. The apparatus of claim 9, wherein the instructions are further executable by the processor to cause the apparatus to:
receive, from the second UE, a request for an indication of non-preferred resources, wherein transmitting the inter-UE coordination message is based at least in part on receiving the request.

11. The apparatus of claim 9, wherein the instructions are further executable by the processor to cause the apparatus to:
receive configuration information indication one or more conditions, wherein transmitting the inter-UE coordination message is based at least in part on the one or more conditions being satisfied.

12. The apparatus of claim 9, wherein the instructions are further executable by the processor to cause the apparatus to:
receive, from the second UE, an indication that the second UE is capable of receiving the inter-UE coordination message, wherein transmitting the inter-UE coordination message is based at least in part on receiving the indication that the second UE is capable of receiving the inter-UE coordination message.

13. The apparatus of claim 9, wherein the instructions are further executable by the processor to cause the apparatus to:
transmit, in the inter-UE coordination message, an indication of a first subset of the plurality of sidelink resources that are non-preferred due to in-device co-existence interference.

14. The apparatus of claim 1, wherein the instructions are further executable by the processor to cause the apparatus to:
monitor for sidelink signaling from the second UE based at least in part on the resource reservation message; and
detect the in-device co-existence interference on at least the portion of the set of sidelink resources based at least in part on the monitoring, wherein transmitting the in-device co-existence interference report is based at least in part on detecting the in-device co-existence interference.

15. An apparatus for wireless communications at a first user equipment (UE), comprising:
a processor;
memory coupled with the processor; and
instructions stored in the memory and executable by the processor to cause the apparatus to:
receive, from a network entity, a resource reservation message indicating a set of sidelink resources for performing sidelink communications with at least a second UE;
communicate with the second UE according to the resource reservation message; and
transmit, to the network entity based at least in part on performing the sidelink communications, an in-device co-existence interference report indicating in-device co-existence interference corresponding to at least a portion of the set of sidelink resources.

16. The apparatus of claim 15, wherein the instructions to transmit the in-device co-existence interference report are executable by the processor to cause the apparatus to:
transmit a radio resource control message comprising an indication of at least the portion of the set of sidelink resources experiencing the in-device co-existence interference.

17. The apparatus of claim 15, wherein the instructions to transmit the in-device co-existence interference report are executable by the processor to cause the apparatus to:
transmit a UE assistance information message comprising an indication of at least the portion of the set of sidelink resources experiencing the in-device co-existence interference.

18. The apparatus of claim 15, wherein the instructions are further executable by the processor to cause the apparatus to:
receive, from the second UE, an indication of the in-device co-existence interference, wherein transmitting the in-device co-existence interference report comprises forwarding the indication of the in-device co-existence interference to the network entity.

19. The apparatus of claim 15, wherein the instructions to transmit the in-device co-existence interference report are executable by the processor to cause the apparatus to:
transmit an indication of the in-device co-existence interference associated with the set of sidelink resources of a first radio access technology impacting wireless communications via a second radio access technology.

20. The apparatus of claim 15, wherein the instructions are further executable by the processor to cause the apparatus to:
transmit, in the in-device co-existence interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by in-device co-existence interference.

21. A method for wireless communications at a first user equipment (UE), comprising:
receiving, from a second UE, reporting information for indicating in-device co-existence interference;
receiving, from the second UE, a resource reservation message indicating a set of sidelink resources; and
transmitting, to the second UE according to the reporting information, an in-device co-existence interference report indicating in-device co-existence interference corresponding to at least a portion of the set of sidelink resources.

22. The method of claim 21, wherein receiving the reporting information comprises:
receiving sidelink radio resource control signaling comprising the reporting information, wherein the reporting information comprises an indication that in-device co-existence interference reporting by the first UE is enabled.

23. The method of claim 21, wherein receiving the reporting information comprises:
receiving a measurement object configuration message, a sidelink assistance information message or an inter-UE coordination information message.

24. The method of claim 21, further comprising:
transmitting, in the in-device co-existence interference report, an indication of one or more carrier frequencies, one or more sidelink bandwidth parts, one or more sidelink resource pools, one or more sidelink subchannels, one or more sidelink physical resource blocks, a range of frequency resources or any combination thereof, affected by the in-device co-existence interference.

25. The method of claim 21, wherein transmitting the in-device co-existence interference report comprises:
transmitting an indication of a link failure associated with the set of sidelink resources due to the in-device co-existence interference.

26. The method of claim 21, further comprising:
receiving, in the reporting information, event-triggered measurement object configuration; and
detecting the in-device co-existence interference based at least in part on monitoring the set of sidelink resources in accordance with the event-triggered measurement object configuration, wherein transmitting the in-device co-existence interference report comprises transmitting a media access control (MAC) control element (CE) based at least in part on detecting the in-device co-existence interference.

27. The method of claim 21, wherein transmitting the in-device co-existence interference report comprises:
groupcasting the in-device co-existence interference report to a plurality of sidelink UEs comprising the second UE.

28. The method of claim 21, wherein transmitting the in-device co-existence interference report comprises:
transmitting an inter-UE coordination message comprising an indication that a plurality of sidelink resources comprising at least the portion of the set of sidelink resources are non-preferred resources.

29. The method of claim 21, further comprising:
monitoring for sidelink signaling from the second UE based at least in part on the resource reservation message; and
detecting the in-device co-existence interference on at least the portion of the set of sidelink resources based at least in part on the monitoring, wherein transmitting the in-device co-existence interference report is based at least in part on detecting the in-device co-existence interference.

30. A method for wireless communications at a first user equipment (UE), comprising:
receiving, from a network entity, a resource reservation message indicating a set of sidelink resources for performing sidelink communications with at least a second UE;
communicating with the second UE according to the resource reservation message; and
transmitting, to the network entity based at least in part on performing the sidelink communications, an in-device co-existence interference report indicating in-device co-existence interference corresponding to at least a portion of the set of sidelink resources.
